(19) United States
(12) Patent Application Publication
(10) Pub. No.: US 2016/0189210 A1
(43) Pub. Date: Jun. 30, 2016

(54) SYSTEM AND METHOD FOR APPYING DATA MODELING TO IMPROVE PREDICTIVE OUTCOMES

(71) Applicant: Sailthru, Inc., New York, NY (US)

(72) Inventors: Ethan Lacey, New York, NY (US); Jeremy Stanley, Oakland, CA (US); Neil James Capel, New York, NY (US)

(21) Appl. No.: 14/984,634

(22) Filed: Dec. 30, 2015

Related U.S. Application Data
(63) Continuation-in-part of application No. 14/812,701, filed on Jul. 29, 2015.
Application No. 14/812,701 is a continuation-in-part of application No. 14/262,361, filed on Apr. 25, 2014.
Application No. 14/262,361 is a continuation-in-part of application No. 13/041,444, filed on Mar. 7, 2011, now Pat. No. 9,158,733.
(60) Provisional application No. 62/098,822, filed on Dec. 31, 2014.
(60) Provisional application No. 62/030,475, filed on Jul. 29, 2014.
(60) Provisional application No. 61/311,356, filed on Mar. 7, 2010.
(60) Provisional application No. 61/816,127, filed on Apr. 25, 2013.

(51) Int. Cl. G06Q 30/02; G06N 99/00; G06N 7/00; G06Q 10/06

(52) U.S. Cl. CPC G06Q 30/0254; G06Q 30/0204; G06Q 10/067; G06N 99/005; G06N 7/005

(57) ABSTRACT

In one or implementations, electronic usage information that is associated with recency, frequency and monetary spending from a plurality of computing devices associated with a user base representing a plurality of users is processed. For example, the electronic usage information is associated with activity, and a portion of the user base is segmented as a function of the associated electronic usage activity. Moreover, using the at least one processor, the associated electronic usage information and the segmented portion of the user base is processed to generate at least one predictive model of future behavior of the segmented portion. Aa respective recommendation of a good and/or service is determined for each of the users in the segmented portion of the user base in accordance with the at least one generated predictive model, and is provided.

### CROSS-REFERENCE TO RELATED APPLICATIONS

This application is based on and claims priority to U.S. Provisional Patent Application Ser. No. 62/098,822, filed Dec. 31, 2014, and is further a continuation-in-part of U.S. Non-Provisional patent application Ser. No. 14/812,701, filed Jul. 29, 2015, each of which is incorporated by reference as if expressly set forth in their respective entirety herein.

### FIELD

The present application relates, generally, to networks and, more particularly, to improved operability for engaging consumers.

### BACKGROUND

Various providers of goods and services (e.g., merchants) continue to seek new ways to engage users. Push notifications, for example, enable a merchant to send a message to a group of users at some specific time, for example to the users' mobile devices. When received, the devices show an alert, and the next time the users activate their devices, the notification is visible. The users then decide the next step. Unfortunately, it is recognized that too often users simply take no further action and/or forget about the message they just received.

### SUMMARY

Technologies are presented herein in support of systems and methods for applying machine learning to define at least one respective segment of a user base and predicting behavior associated with the segment. In one or implementations, electronic usage information that is associated with recency, frequency and monetary spending from a plurality of computing devices associated with a user base representing a plurality of users is processed. For example, the electronic usage information is associated with activity, and a portion of the user base is segmented as a function of the associated electronic usage activity. Moreover, using the at least one processor, the associated electronic usage information and the segmented portion of the user base is processed to generate at least one predictive model of future behavior of the segmented portion. Aa respective recommendation of a good and/or service is determined for each of the users in the segmented portion of the user base in accordance with the at least one generated predictive model, and is provided.

These and other aspects, features, and advantages can be appreciated from the accompanying description of certain embodiments of the invention and the accompanying drawing figures and claims.

### BRIEF DESCRIPTION OF THE DRAWINGS

FIG. 1 shows an example hardware arrangement for viewing, reviewing and outputting content in accordance with an implementation;

FIG. 2 is a block diagram that illustrates functional elements of a computing device in accordance with an embodiment;

FIG. 3 is a block diagram illustrating a network of parties in accordance with one or more implementations of the present application;

FIGS. 4A-6L identify example data, data modeling, visualizations and resulting predictions associated with various behavior, including purchase probability, opting-out of one or more mail campaigns, and revenue earning in accordance with one or more implementations of the present application;

FIG. 7 illustrates a table that includes values and a simple chart that graphically represents corresponding k-Tile values associated with a plurality of predictions;

FIGS. 8A and 8B illustrate example data entry display screens that enable a client to build one or more data queries using various criteria in accordance with one or more implementations of the present application;

FIG. 9 illustrates an example data report that identifies the results of a query defined by a client;

FIG. 10 illustrates example options provided with a query builder in accordance with an example implementation of the present application;

FIG. 11 illustrates an example data entry display screen in which programming is provided and used for utilizing predictions in accordance with an example implementation;

FIGS. 12A and 12B illustrate example custom email messages for respective users in view of predictions made in accordance with the present application; and

FIGS. 13A-13I illustrate example data entry display screens in accordance with a graphical user interface in an example implementation of the present patent application featuring inflection points to create segments of a user base.

### DETAILED DESCRIPTION

The present application provides a computerized platform for predicting user behavior, and for developing and managing user communications such as email campaigns, in response to such predictions. For example, graphical user interfaces are provided for data modeling, for data review and for providing visualizations of modeling results, as well as for improving user communications and data management relating to email campaigns, email lists of subscribers for mass mailings, and formatting communications.

In one or implementations, a user-interface platform is provided that identifies a at least one segmented group of a user base associated with one or more predictions. One or more modules of the present application processes information to determine or enable users to define respective population segments, and presents the segments for targeting for specific treatments. For example, a percentage of a user base may generate $300 of revenue, per user. Alternatively, the same percentage of the user base may generate $3,000, per user. The present application provides access to such information prior to the user base engaging in purchases, thereby enabling strategic targeting of the percentage of the user base with goods or services that are priced within the predicted revenue. Moreover, one or more modules of the present application can determine respective percentage of users that are predicted to generate revenue, which is further usable for strategic targeting. This provides for substantial predictive visibility into a user base, including to provide the mean, median, total value, and total number of users associated with each of one or more respective prediction.

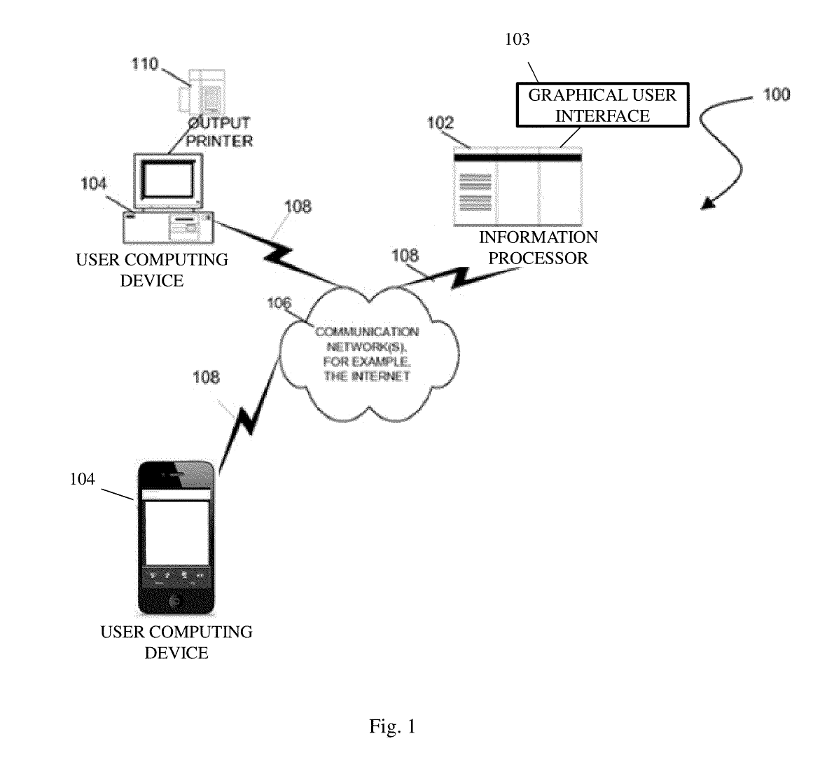

Referring now to the drawings in which like reference numerals refer to like elements, there is shown in FIG. 1 a diagram of an example hardware arrangement that operates for providing the systems and methods disclosed herein, and designated generally as system 100. The example system 100 is preferably comprised of one or more information processor 102 coupled to one or more user computing devices 104 across communication network 106. User computing devices 104 may include, for example, mobile computing devices such as tablet computing devices, smartphones, personal digital assistants or the like. Further, printed output is provided, for example, via output printers 110.

Information processor 102 preferably includes all necessary databases for the present invention, including image files, metadata and other information relating to artwork, artists, and galleries. However, it is contemplated that information processor 102 can access any required databases via communication network 106 or any other communication network to which information processor 102 has access. Information processor 102 can communicate devices comprising databases using any known communication method, including a direct serial, parallel, USB interface, or via a local or wide area network. Database(s) that are accessible by information processor 102 can contain and/or maintain various data items and elements that are utilized throughout the various operations of the system (100). For example, the database(s) can include user information including account information concerning the user's various accounts third-party content and service providers. The database(s) can also include user preferences concerning operation of the system 100 and other settings related to the third-party content and service providers. By way of further example, the database(s) can also include a library of digital media content or products for sale.

User computing devices 104 communicate with information processor 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 104 preferably have the ability to send and receive data across communication network 106, and are equipped with web browsers to display the received data on display devices incorporated therewith. By way of example, user computing device 104 may be personal computers such as Intel Pentium-class computers or Apple Macintosh computers, but are not limited to such computers. Other computing devices which can communicate over a global computer network such as palmtop computers, personal digital assistants (PDAs) and mass-marketed Internet access devices, such as a smart television, can be used. In addition, the hardware arrangement of the present invention is not limited to devices that are physically wired to communication network 106. Of course, one skilled in the art will recognize that wireless devices can communicate with information processor 102 using wireless data communication connections (e.g., Wi-Fi).

System 100 preferably includes software that provides functionality described in greater detail herein, and preferably resides on one or more information processor 102 and/or user computing devices 104. One of the functions performed by information processor 102 is that of operating as a web server and/or a web site host. Information processor 102 typically communicate with communication network 106 across a permanent i.e., unswitched data connection 108. Permanent connectivity ensures that access to information processor 102 is always available.

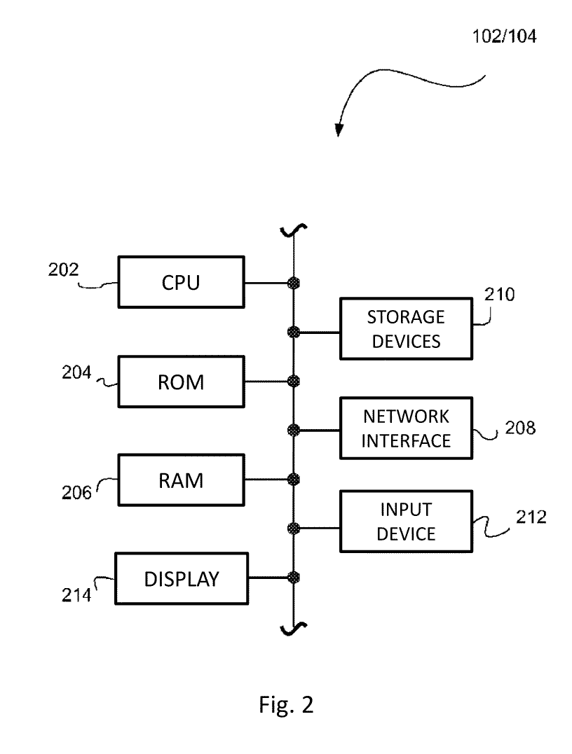

As shown in FIG. 2 the functional elements of each information processor 102 or computing device 104, and preferably include one or more processors 202 used to execute software code in order to control the operation of information processor 102, read only memory (ROM) 204, random access memory (RAM) 206 or any other suitable volatile or non-volatile computer readable storage medium, which can be fixed or removable. FIG. 2 also includes one or more network interfaces 208 to transmit and receive data to and from other computing devices across a communication network. The network interface 208 can be any interface that enables communication between the any of the devices (e.g., 102, 104, 110) shown in FIG. 1 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the devices and/or communication networks, such as private networks and the Internet. Such connections can include a wired connection or a wireless connection (e.g., using the IEEE 802.11 standard known in the relevant art) though it should be understood that network interface 208 can be practically any interface that enables communication to/from the processor 202.

Continuing with reference to FIG. 2, storage device(s) 210 can be included such as a hard disk drive, floppy disk drive, tape drive, CD-ROM or DVD drive, flash memory, rewritable optical disk, rewritable magnetic tape, or some combination of the above for storing program code, databases and application code. In certain implementations, memory 204, 206 and/or storage device(s) 210 are accessible by the processor 202, thereby enabling the processor 202 to receive and execute instructions stored on the memory 204, 206 and/or on the storage 210. Further, elements include one or more input devices 212 such as a keyboard, mouse, track ball and the like, and a display 214. The display 214 can include a screen or any other such presentation device that enables the system to instruct or otherwise provide feedback to the user regarding the operation of the system (100). By way of example, display 214 can be a digital display such as an LCD display, a CRT, an LED display, or other such 2-dimensional display as would be understood by those skilled in the art. By way of further example, a user interface and the display 214 can be integrated into a touch screen display. Accordingly, the display is also used to show a graphical user interface, which can display various data and provide “forms” that include fields that allow for the entry of information by the user. Touching the touch screen at locations corresponding to the display of a graphical user interface allows the user to interact with the device to enter data, control functions, etc. So when the touch screen is touched, interface communicates this change to processor, and settings can be changed or user entered information can be captured and stored in the memory.

One or more software modules can be encoded in the storage device(s) 210 and/or in the memory 204, 206. The software modules can comprise one or more software programs or applications having computer program code or a set of instructions executed in the processor 202. Such computer program code or instructions for carrying out operations or aspects of the systems and methods disclosed herein can be written in any combination of one or more programming languages, as would be understood by those skilled in the art. The program code can execute entirely on one computing device (e.g., information processor 102) as a stand-alone software package, partly on one device and partly on one or more remote computing devices, such as, a user computing device 104, or entirely on such remote computing devices. In the latter scenario and as noted herein, the various computing devices can be connected to the information processor 102 through any type of wired or wireless network, including a local area network (LAN) or a wide area network (WAN), or the connection can be made to an external computer (for example, through the Internet using an Internet Service Provider). It should be understood that in some illustrative embodiments, one or more of the software modules can be downloaded over a network from another device or system via the network interface 208. For instance, program code stored in a computer readable storage device in a server can be downloaded over a network from the server to the storage 210.

It is to be appreciated that several of the logical operations described herein are implemented (1) as a sequence of computer implemented acts or program modules running on the various devices of the system 100 and/or (2) as interconnected machine logic circuits or circuit modules within the system (100). The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Thus, the various components of information processor 102 need not be physically contained within the same chassis or even located in a single location. For example, as explained above with respect to databases which can reside on storage device 210, storage device 210 may be located at a site which is remote from the remaining elements of information processor 102, and may even be connected to CPU 202 across communication network 106 via network interface 208.

The nature of the present application is such that one skilled in the art of writing computer executed code (software) can implement the described functions using one or more or a combination of a popular computer programming languages and technologies including, but not limited to, C++, VISUAL BASIC, JAVA, ACTIVEX, HTML, XML, ASP, SOAP, IOS, ANDROID, TORR and various web application development environments.

As used herein, references to displaying data on user computing device 104 refer to the process of communicating data to the computing device across communication network 106 and processing the data such that the data can be viewed on the user computing device 104 display 214 using a web browser or the like. The display screens on user computing device 104 present areas within control allocation system 100 such that a user can proceed from area to area within the control allocation system 100 by selecting a desired link. Therefore, each user's experience with control allocation system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 100.

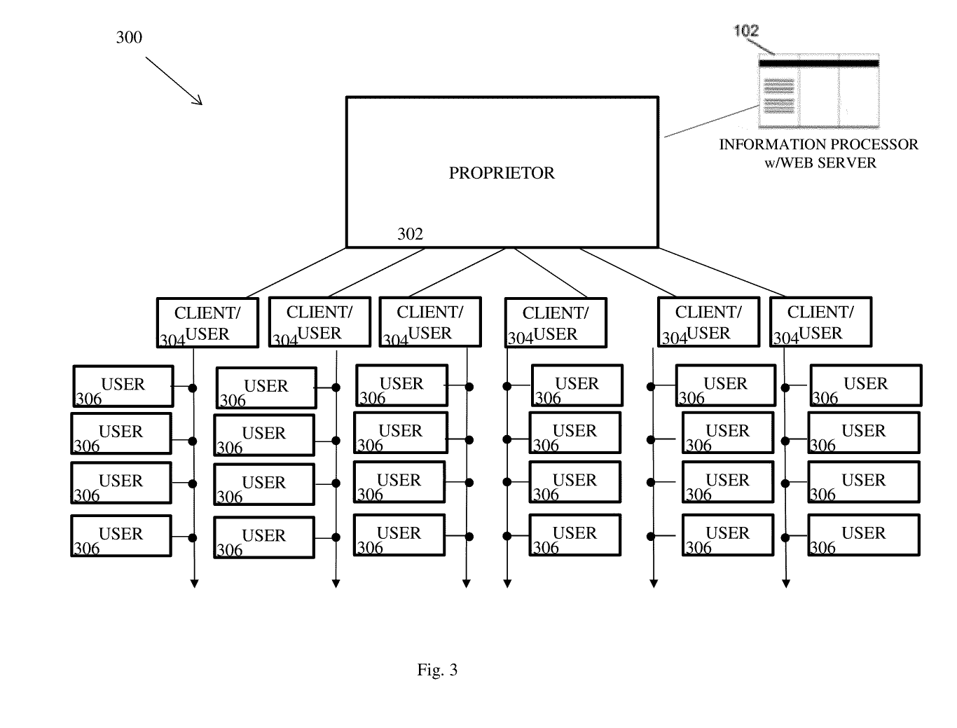

FIG. 3 is a block diagram illustrating a network of parties 300 in accordance with one or more implementations of the present application. As shown in FIG. 3, plurality of clients 304 of proprietor 302 are communicatively coupled together, such as via information processor 102 and user computing devices 104 and communication network 106. Clients/Users 304 avail themselves of functionality proprietor 302 offers via information processor 102 substantially as shown and/or described herein. Such functionality is usable by clients/users 304 to service their respective users 306. Thus and as shown in FIG. 3, a plurality of users 306 are respectively serviced by clients/users 304 of proprietor 302, including to receive email messages, newsletters, alerts or other content that can be customized for each respective user 306. In this way, the teachings herein provide for propagation of technology and functionality across many different industries and technologies.

The present application can be configured to include hardware and software features and functionality, and can include various modules that are programmatically tied to a graphical user interface and/or application programming interfaces (“API”) and software development kits (“SDK”), which are supported by information processor 102. In one or more implementations, APIs provide various functionality that enable users 304 to provide customized content to users 306. Particular selections of customized content may be made in accordance with historical activity and/or behavior of respective users 306. For example, one user 306 (e.g., Sarah) typically reads content (e.g., articles) associated with politics, while another user 306 (e.g., John) typically cares more about sports. Accordingly, content about breaking political updates is selected for and delivered to Sarah and content about a preferred sports team is selected for and delivered to John. Preferences of a respective user 306 can be used by clients/users 304 in formulation of data profiles. Data profiles of users 306 are usable to generate and transmit communications, substantially as shown and described herein.

In one or more implementations event-level data, such as relating to individual purchases, messages received, whether or not users interact with messages, web sites and/or mobile applications, are received by information processor 102 and stored in one or more databases. Functionality is provided to process information associated with individual clients' past behavior, such as regarding the user's interactions, and one or more predictive models are built that are usable to form accurate predictions about future behavior. For example, an e-commerce client may have one million users, and predictions are made regarding the probability of one or more of the users taking some form of action (e.g., making a purchase) within a predefined time period, such as 30 days.

Predictive information that is formed in accordance with the present application can be provided to clients in a particular context that is meaningful for the client. Various kinds of predictions can include:

Return to Site: probability a user will return to the site (given a user); Expected Page Views: expected number of page views (given a user); Email Bounce: probability an email sent to a user will bounce (given an email); Email Spam: probability an email sent to a user will be marked as spam (given an email); Email Open: probability a user will open an email they receive (given an email); Email Click: probability a user will click on an email they receive (given an email); Add to Cart: probability a user will add products to their shopping cart (given a user); Abandon Cart probability a user will add products to their shopping cart then abandon them (given a user); Purchase: probability a user will make a purchase (given a user); Purchase Value: expected purchase value (given a purchase); Purchase Basket Size: expected number of items purchased (given a purchase); Email Opt Out: probability that a user will opt out of all email (given sent an email); “Concierge” Opt Out: probability a user will opt out of concierge (given a page view with concierge); “Scout” Opt Out: probability a user will opt out of scout (given a page view with scout); Discount: probability of purchasing with a discount. Predictions can be written to the client's user profile collection as variables and, for example, prefixed with a reserved 2 identifier, such as “st_” to differentiate them from other client vars. Each model can predict either a probability (when modeling the chance of something occurring—like a page view) or an expected_value (when modeling the expected value of an outcome—like dollars purchased). Values can be stored directly, or can apply transformations to them that may be more helpful to clients 304.

The following represents a specific example implementation:

“openrate_7” represents a likelihood of a user 306 to open within next 7 days;

“purchase_30” represents a likelihood of a user 306 to purchase within next 30 days;

“aiv_7” represents a predicted number items in cart if a purchase is predicted within next 7 days;

“aov_7” represents a predicted transaction total of purchase ($) if a purchase is predicted within next 7 days;

“optout_7” represents a likelihood of a user 306 to opt out of any messaging (email) within next 7 days;

“pv_30” represents a predicted number of pageviews that a user 306 will generate within next 30 days;

“rev_365” represents a predicted total amount of revenue that a user 306 will generate over next 365 days;

“purchase_7” represents a likelihood of a user 306 to purchase within the next 7 days;

“click_7” represents a predicted number of clicks that a user 306 will generate within next 7 days;

“purchase_1” represents a likelihood of a user 306 to purchase within the next day;

“item_7” represents a predicted item value if a purchase is predicted within next 7 days,

“rev_30” represents a predicted total amount of revenue that a user 306 will generate over next 30 days; and

“msgs_1” represents a predicted total number of messages that a user 306 will receive within the next day.

When appropriate, incentives such as discounts and other bonuses can be used to incentivize users, including those who have a relatively low probability of making a purchase. Other discounts can be provided for users for orders that may be higher in value than the user's 306 expected purchase amount. Moreover, special rewards can be provided for VIPs. Users who may be identified as having relatively low expected page view counts can also be reengaged with customized and particular content. Moreover, those users that are likely to opt out can be added to a suppression list, which is designed to increase the user′ 304 interest over time.

In one or more implementations, information is provided as a function of a k-Tile, which is like a percentile but based on 1,000 as opposed to 100, and increases granularity of the data. In one or more implementations, a module implements an application of an algorithm in which the users are sorted in a rank order as a function of a likeliness to perform one of the predicted events (as shown and described herein), and the user base is divided by 1000. The result is that the top 1000th k-Tile (or top 0.1% of all users) are the predicted users who are most likely to perform a predicted event.

For example, one user might have a 3% chance of purchasing a product within the next 30 days. And that would put the user in the top 998 k-Tile, while another user might just have a 0.1% chance of purchasing, which would put that user in 300 k-Tile. A variety of predictions, for example, relating to nine different categories can be made as a function of a k-Tile and the predictions can be provided in a data “asset” for clients and that are usable for, for example, personalizing communications, websites or the like, as well as to assist with building lists of clients and developing new messages and potentially to control experiences of users.

The present application is configured to process information and values associated with user activity recency, frequency and monetary (“RFM”) to form explicit predictions for users. For example, predictions can be made for how much money users are likely to spend, or the likelihood of making purchases or average order values. In addition to RFM, the present application processes information associated with different variables, such as a time series of purchasing events, and the shape of a particular time series is analyzed, for example, to see how much volatility there is in the amounts that were purchased. In one or more implementations, information associated with inter-arrival times of purchase events are process, as are rates of change of one or more elements in a respective time series. Many different computations associated with a particular time series can become features of predictive models and used to learn and predict future behavior. In another example, repeat visits to one or more Internet websites are identified, as well as a time series associated with respective page views. Processing such information determines whether users engage with any of the communications in email or mobile platforms. Moreover, predictive models associated with the present application can be frequently and regularly rebuilt, and as clients' 304 businesses model change or user behavior changes in some systemic way, the models will pick that up and learn such changes. The models are configured to adapt and continuously update the predictions being updated without the client having to go in and conduct manual analysis.

Moreover, a point which indicates mathematically where one segment of users transitions into another, such as a break where medium spenders become high spenders, is referred to herein, generally, as an inflection point. Inflection points represent useful demarcations of groups of users for example, for specific targeting. In one or more implementations, module(s) accessed and/or operated by information processor 102 and/or user computing device 104 automatically identify inflection points and corresponding segments of a user base. Information associated with behavioral predictions, such as shown and described herein, is automatically provided within the GUI to instruct and/or recommend particular practices that should be followed to maximize return for client 304. For example, segmented groups of user and corresponding predicted degrees of behavior (e.g., opt-out, purchase, etc.) such as very likely, somewhat likely, less likely or highly unlikely can be identified and appropriate steps can be automatically and/or substantially automatically taken as a result of the predicted result and strategically leverage the segmented groups. In one or more implementations, a number of inflection points can be substantially and/or automatically determined, such as a function of Bayesian nonparametrics.

In one or more implementations, two methods are usable for defining inflection points: a decision tree method and a second derivative method. With regard to the decision tree method, a decision tree learning model can be trained to predict behavior for a given user based on the k-Tile value, as shown and describe herein. A decision tree can be built with a depth of two, thereby yielding four distinct intervals of k-Tiles. The boundary points of the four distinct intervals are usable as inflection points. The decision tree learning model technique solves regression and classification issues, in which a hierarchical tree-like structure is built in a stepwise fashion.

With regard to the second derivative method, an interpolation technique, such as the cubic spline method, is used to create a smooth function from k-Tile values to the average predicted outcome for users in a respective k-Tile. The second derivative of the interpolating function is computed, and points in which the second derivative is equal to zero are used as inflection points.

In one or more implementations, the present application provides functionality to define predictions for user behavior specific to a particular client's 304 business. This enables a client 304 to target users based on actions, events and/or behaviors that drive the client's 304 bottom line, based on the respective business model.

For example, the present application provides clients 304 an ability to define behaviors of their users for which predictions are desired. In one or more implementation, this can be accomplished by tagging a user's profile when the particular behavior occurs. A prediction engine can be provided that analyzes information associated with the profiles, including information representing when users have engaged in the behavior, those that have not, how frequently, and how recently. Clients 304 can be provided with access to custom predictions through a plurality of channels. The custom prediction can be offered in a number and k-Tile format.

It is recognized herein that various clients 304 have a significant number of different business models. Often, what drives a bottom line is not a standard purchase or page view. Some clients have hybrid business models, some have subscription models, and nearly all define conversions in a different way. Custom predictions provide a compliment to standard commerce or media business models, by enabling a client to predict different steps that lead to a conversion.

In one or more implementations, an established machine grade learning technique is used, such as a gradient boosting machine, which builds many small decision trees, each one improving the performance of the prior. In addition or in the alternative, glmnet and L1 regularized logistic regression algorithms can be used for building models, and which can be combined in an ensemble production. As used herein, gradient boosting refers, generally, to a machine learning technique for solving regression problems, which produces a prediction model in the form of an ensemble of prediction models, typically decision trees. A model is built in a stage-wise fashion are generalized by allowing optimization of an arbitrary differentiable loss function. The gradient boosting method can also be used for classification problems by reducing them to regression with a suitable loss function.

In an implementation, an individual predictive model can comprise 3,000 decision trees, and hundreds of different variants can be built to make an individual predictive model for a respective client. As user interactions are processed, the model adapts depending, for example, on the degree of complexity of the tree and the information being processed. A variety of machine learning features can be created from the data, such that quantitative tools and measures (e.g., data tables and graphical representations) can be built that represent past and future user behavior. That quantitative measure can take various forms, such as the number of seconds since a user last visited a site, the rate of change of the inter-arrival times in a user's site visitations, or variants in the amounts that a user purchased over a period of time, such as the previous 365 days. Hundreds of different quantitative measures can be built and used to infer the shape of data thereby leading to improved predictions.

As noted herein, the present application accounts for a frequency of updating of predictions. Information processor 102 and/or user computing device 104 can be, for example, configured to update a prediction regarding a user 306 using two points. The first can be provided when a new user is created. The second can be provided on a periodic basis for all users 306. For example, a real time scoring process can be used which updates predictions for a new user 306 within a period of time, such as 60 seconds. Then a daily batch process can be implemented by information processor 102 and/or user computing device 104 to update predictions for all users 306. This can ensure that predictions will be made for any user 306 that has been added since longer than the period of time (e.g., 60 seconds), and further that predictions for any user 306 predictions can be updated within a period of time, such as the last 24 hours. Scoring new users 306 quickly ensures that they are immediately included in any analytics or strategies that relate to predictions. Further, updating all scores for users 306 periodically can be in view of two factors: User predictor data may change periodically and time series data can change (e.g., decline or “age”) over time.

The present application can be configured to implement one or more modules to structure data and ensure that time is treated effectively and appropriately, thereby enabling a gradient boosting machine to develop and/or implement a formula that improves predicting future behavior. For example, to predict a user's behavior in the future, historical experiments can be run that are based on past data, and user behavior is observed for a month to determine whether or not, for example, purchases have been made. In one or more implementations, features of the machine can be instructed based upon data that was observable prior to a given (e.g., the present) month. Thereafter, the model can take the features and learn the patterns that predict behavior in the following month. The patterns can relate, for example, to data events associated with user interactions with email correspondence that a client is interested in, such as collected via a purchasing API, mobile platform SDK, or the like.

It is recognized that it may be inefficient and/or impractical (though certainly not impossible) to build models on every single user, including due to computational overhead concerns. For example, in an effort to preclude building models for over 10 million users, the present application employs a sampling step to reduce the population of 10 million into a subset that is more practicably usable to train a model. Sampling can be done in a way that preserves the integrity and accuracy of all of the available information. For example, a prediction is being made for a relatively rare event, e.g., a purchase of which 1 out of only 100 users makes in a given time period. In a random sample of 100,000 users, 100,000 rows of data are provided in which only 1,000 of those rows represent purchase events and the other 99,000 rows do not. This is not an efficient way to train a model. In an implementation, for example, 50,000 users who made a purchase are sampled and 50,000 users who did not make purchases are sampled, and weights are assigned to those who did not make purchases that allow the model to normalize to the broader population.

In one or more implementations, the present application supports one or more clients 310 that have a large user base (e.g., 10 million). One or more models can be built based on a sample of 100,000 of the users. The model(s) can be built using hundreds of gradient boosting machines that comprise thousands of decision trees, each. One or more of the gradient boosting machines can be selected, and predictions are made for all 10 million users. Thereafter, the predictions are “pushed” back and used to populate one or more databases accessible to information processor 102 into the database that the client 310 has access to, to be able to personalize or otherwise customize their communications.

The process of selecting one or more of the gradient boosting machines can be made as a function of a plurality of processes. For example and in cases where a predefined period of time is used, the most recent month within the time period is excluded from the processes of building models. Thereafter, the models are used for making predictions for each user in the last month and the results are evaluated to determine how closely the predictions align with the behavior that actually took place during that month. Any errors in the respective predictions are analyzed and a determination is made to identify the best performing models.

In addition, a determination is made of the number trees to use for the respective models. A given model may have 3,000 trees and use of all trees can cause “overfitting” the data, which can result in learning the noise as opposed to the patterns. Accordingly, the present application applies cross-validation, in which data are parsed into a number (e.g., five) different folds, and models are built on each fold. The performance is reviewed in aggregate across a predefined period of time (e.g., most recent month) for each of the cumulative sets of models ranging from the first tree, up to the next entries, all the way up to, for example, the 3,000 trees and the process stops at a point in which out of sample error(s) start to increase.

A variety of implementations and business models are provided herein including, for example, pushing the data resulting from modeling, as shown and described herein, directly to clients' 304 databases. Alternatively or in addition, predictive and other information can be transmitted to social networking sites, and can be referenced, for example, by information stored in individual user profiles. Data processing application 102 can also support a “real-time” data platform that the clients 304 can use to control their communications to their users 306 and/or to analyze their respective user bases.

Thus, the present application applies machine learning techniques and computer science logic and infrastructure and builds predictive models. This is implemented as a function of a data infrastructure and implementation of algorithms. In addition, the present application supports specific decision-making about the data assets, including to predict the likelihood of various user 306 behavior, such as opting out from receiving email, making a purchase, opening a message or the like, and to implement marketing strategy or the like. Various hypotheses are usable to enable clients 304 to engage with users 306 intelligently. For example, users 306 are identified to be likely to opt out of a campaign (the top 1%). That information is used to suppress the users from a list of recipients of the campaign and the platform dynamically excludes those users from the email until their chance of opting out falls sufficiently. Thereafter, the 1% of clients 306 can begin receiving email again. This results in a smart frequency cap that is employable to prevent opt outs.

In one or more implementations, the present application provides for data visualization that enables identifying data that are useful and significant, and determining how data vary by individual clients, across clients and across different types of models. The present application provides an introspection into how the models are working and what data drive them to work. This is provided, in one or more implementations, by rigorous testing of data in the “holdout” period of time (e.g., the most recent month).

In or more implementations, variable importance is determined by taking individual features and analyzing the degree of impact the variable(s) have on the predictions. Moreover, one or more searches for different combinations of models and/or parameters are tested in terms of performance. For example, visualizations are provided of test results to represent how much “lift” is generated, such as the top 10% of a client's 304 predicted users 306 accounts for 90% of outcomes that the client 304 is interested in. Moreover, the application identifies how well models are calibrated, such that when a model predicts the chance of an event (e.g., an opt-out) occurring and, during a further testing in the “holdout” period, the prediction is determined to be skewed and misleading. In such cases, the models can be calibrated to increase the accuracy of the models and the associated predictions based thereon.

Unlike one single predictive model that is built, and “hand-tuning” the data to that one model, the present application can build thousands of models for hundreds of clients 304. In one or more implementations, the present application analyzes data across a plurality of clients, including to evaluate outliers and distributions, and to identify structural issues that can be used to change the platform and improve the models. This is an improvement over, for example, making ad hoc adjustments to fix one specific issue, but that cannot address broader cause(s) associated with inaccurate models and predications. By analyzing the data across clients, improvements can be made to models overall. Patterns can be visualized across clients and use the results of those patterns to make better decisions about the models than had there been an analysis of a single client. Clients can be split into groups, such as publishers and e-commerce.

Thereafter, categories may be based on a business model, such as for clients 304 that are subscription-based, or are rare event-based are marketplaces, resellers. Accordingly, there may be variations within or among the respective business models. The present application provides one or more modules that ensure effectiveness across all of the respective client groups, thereby obviating a need for particular tuning for respective client groups.

Furthermore, the present application includes an ability for individual clients to customize models, for example, to account for different time durations over the course of an hour, day, month, or the like. In addition or in the alternative, clients 304 can tag various data elements, such as content, items and campaigns, that represent a respective attribute of those entities. When the present application makes a prediction about a particular user 306, such as the likelihood of making a purchase, the tags that are applied by the client 304 can be used for improved filtering and increased granularity with regard to the data analysis. For example, a plurality of tags could be applied for a client that happens to be a subscription-based client and is a “vanilla” e-commerce client. Predictions can be automatically tailored for the two different use cases.

In one or more implementations, a front-end and/or a backend component are provided. For example, a user interface is provided for users to submit tags or other content. In one or more implementations, a “widget” is built in a user profile look up that enables the user to see the predictions in the case highlights for an individual user, and the client 304 can filter on these predictions in order to define a subset of users 306 that score high or low in predictions. This gets fed back into a query engine user interface. In the context of an email campaign template, users can query the data directly using Zephyr or other programming language.

Various implementations can be provided, such as to suppress blast messages based on respective percentage positions of the users 306. For example, the top 1% receive 4+ messages a day. In another implementation, discounts can be offered to high open rate (top 10%), yet low purchase probability users (bottom 90%). In another implementation, grids (e.g., relating to dresses offered) are customized based on an average order value (“AOV”) and use revenue versus their existing RFM segmentation strategy. In another implementation, revenue is used, versus existing RFM segmentation strategy. In another implementation, functionality is provided to engage on a social network site, such as FACEBOOK, with high revenue (top 10%) yet low open rate (bottom 60%) users. Alternatively, build functionality can be provided to engage on a social network site to build look-alike models on high expected revenue users (such as the top 0.5%).

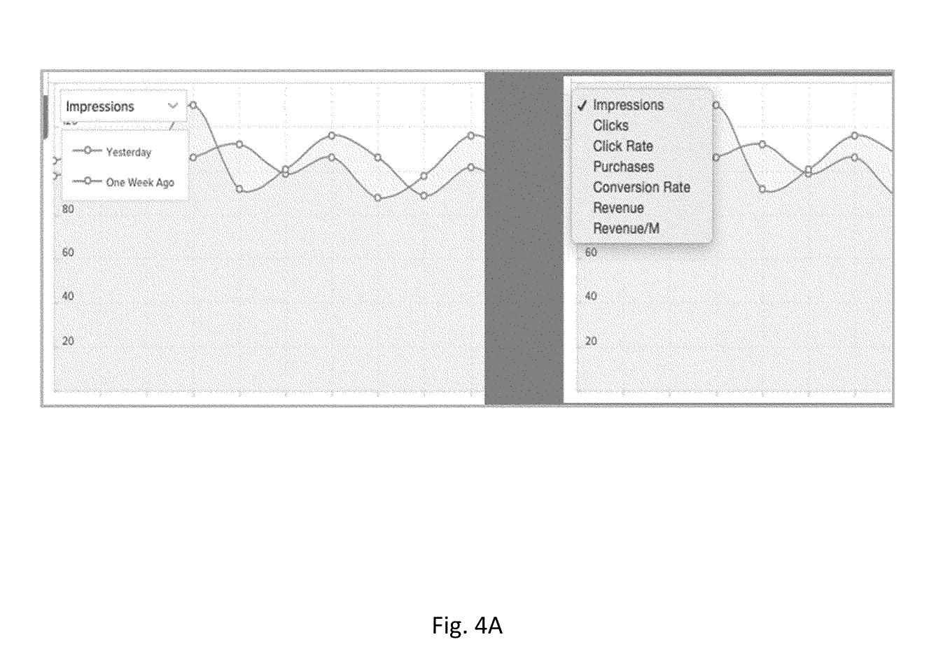

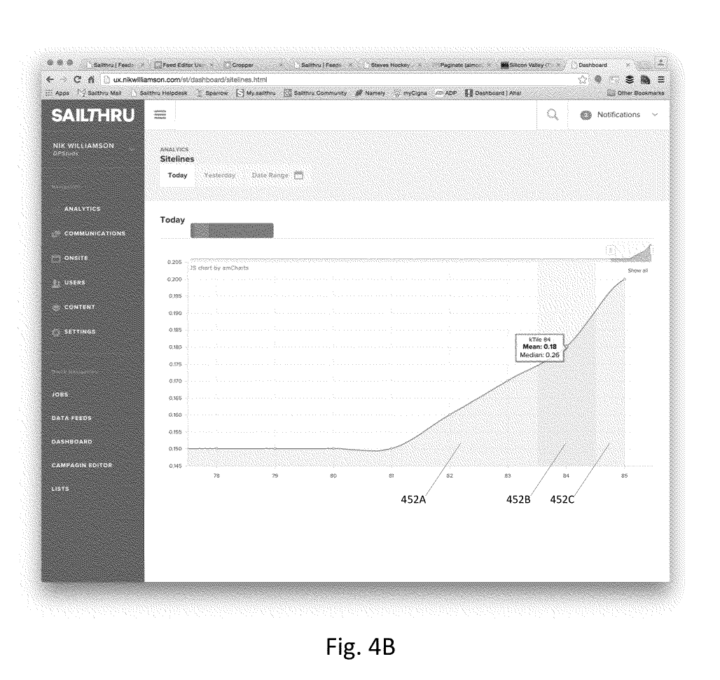

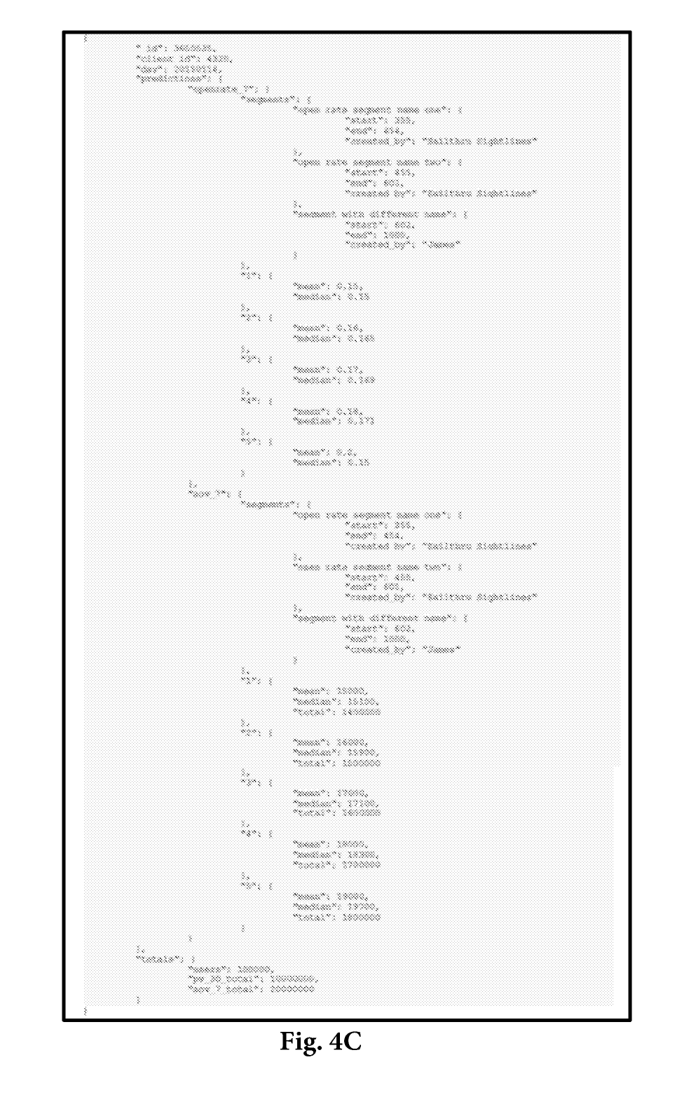

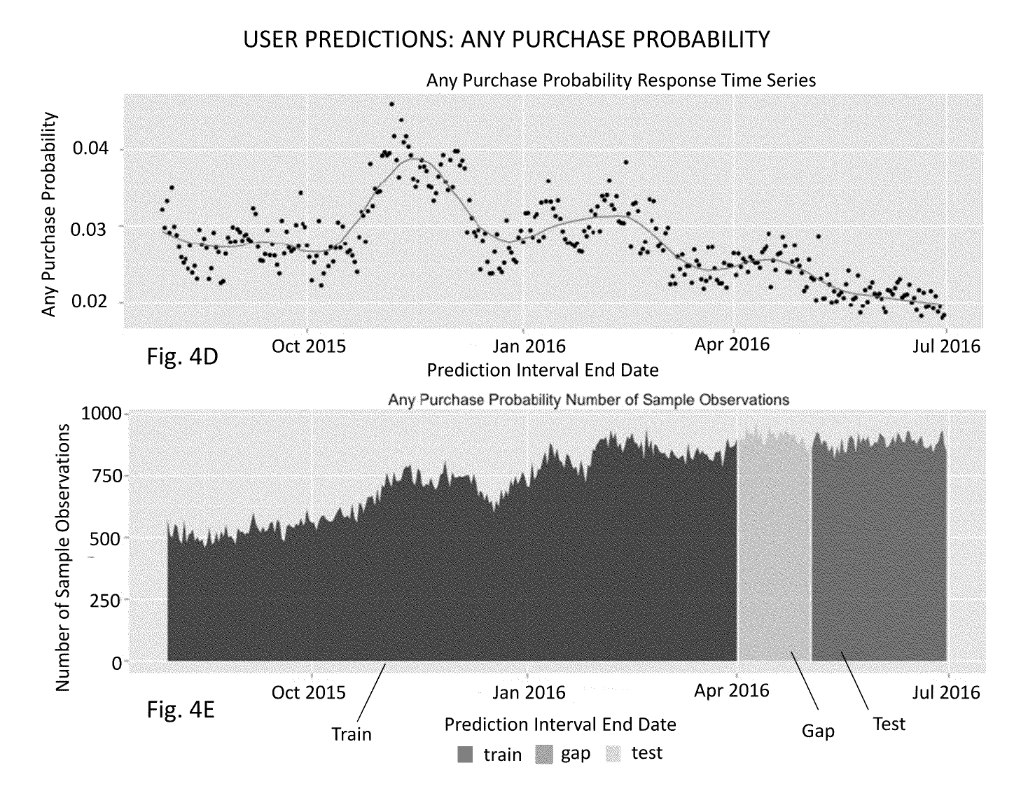

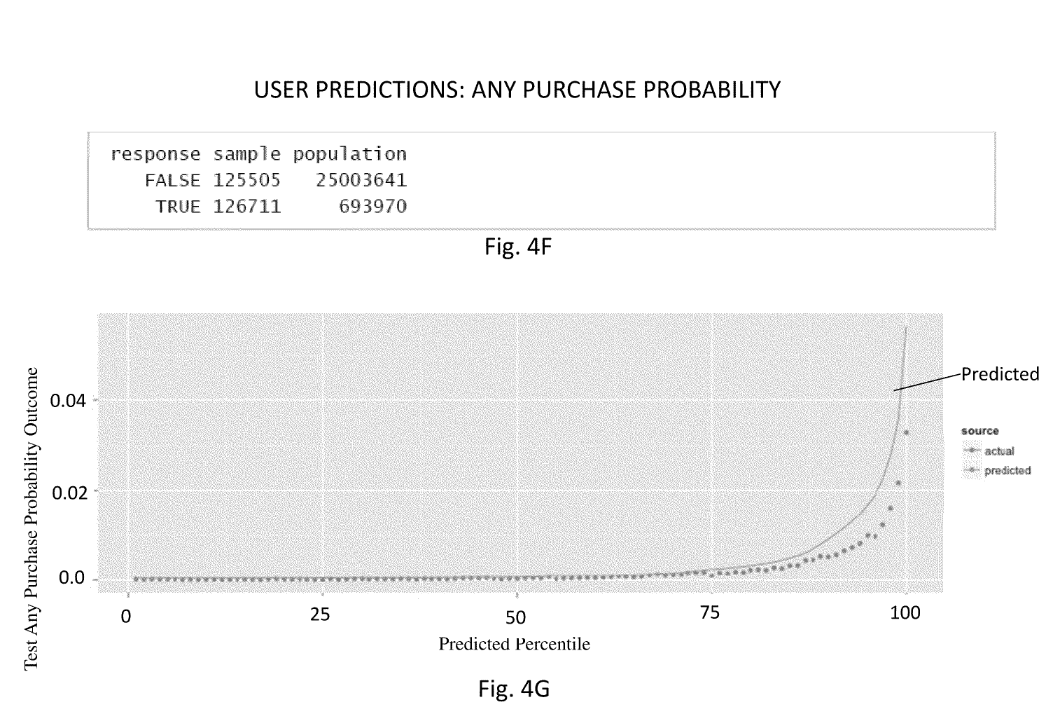

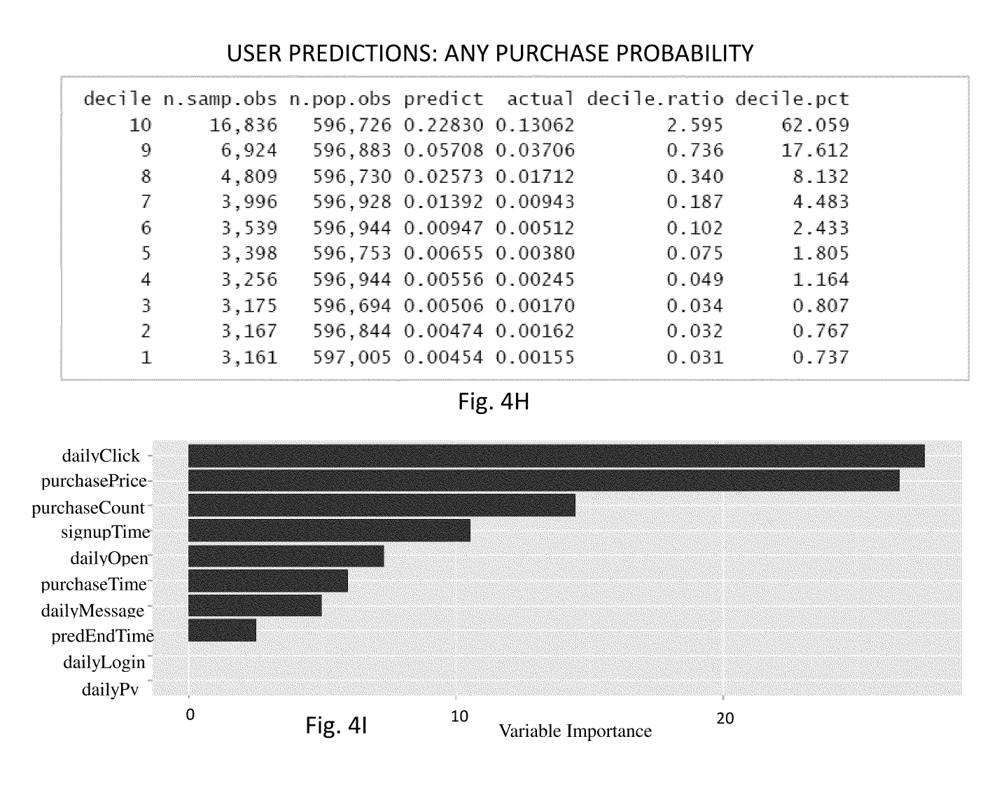

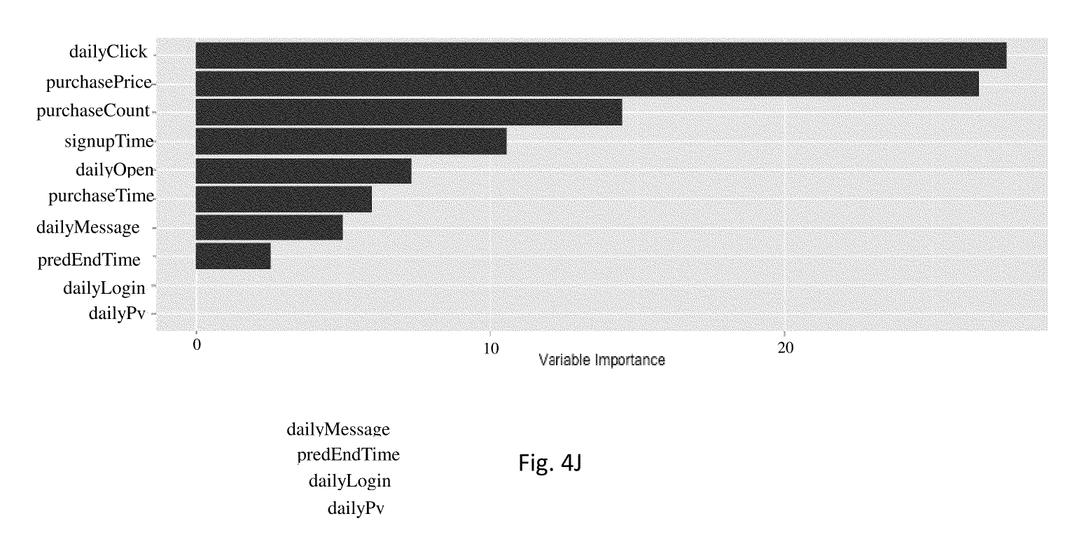

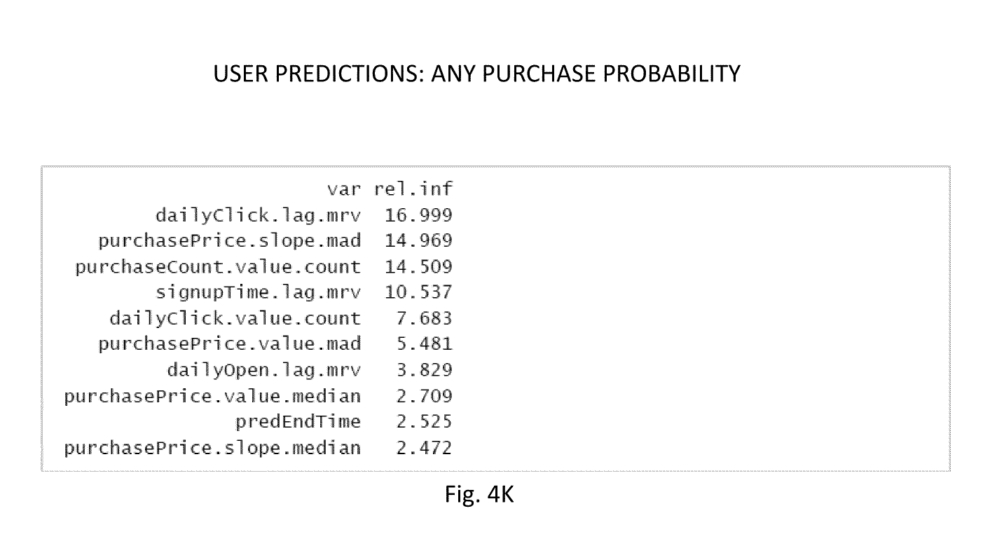

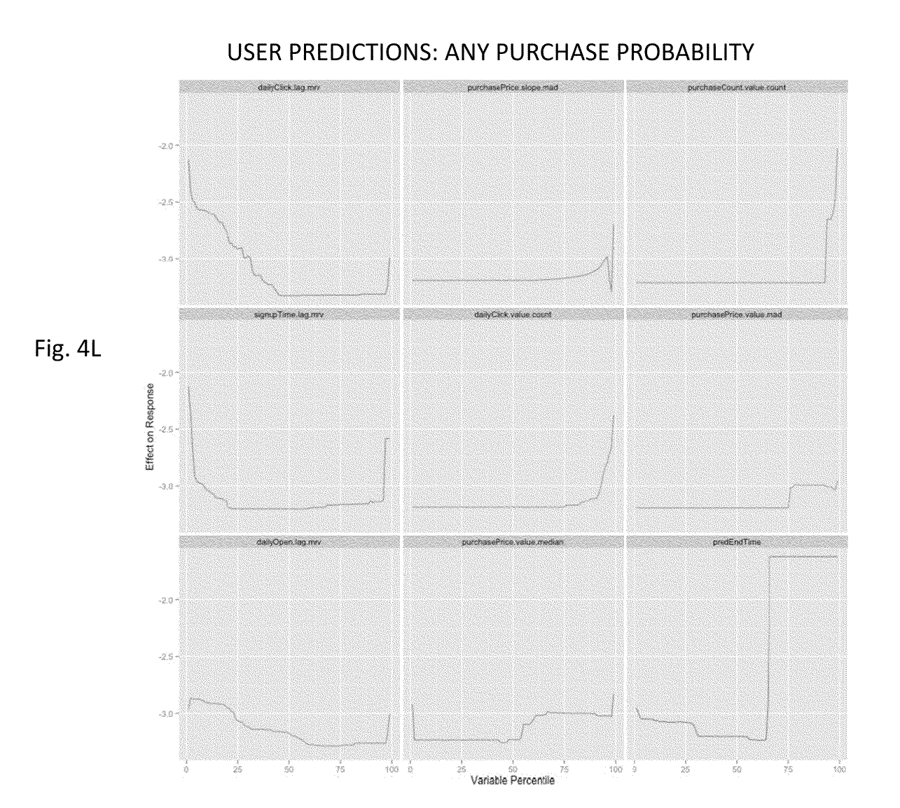

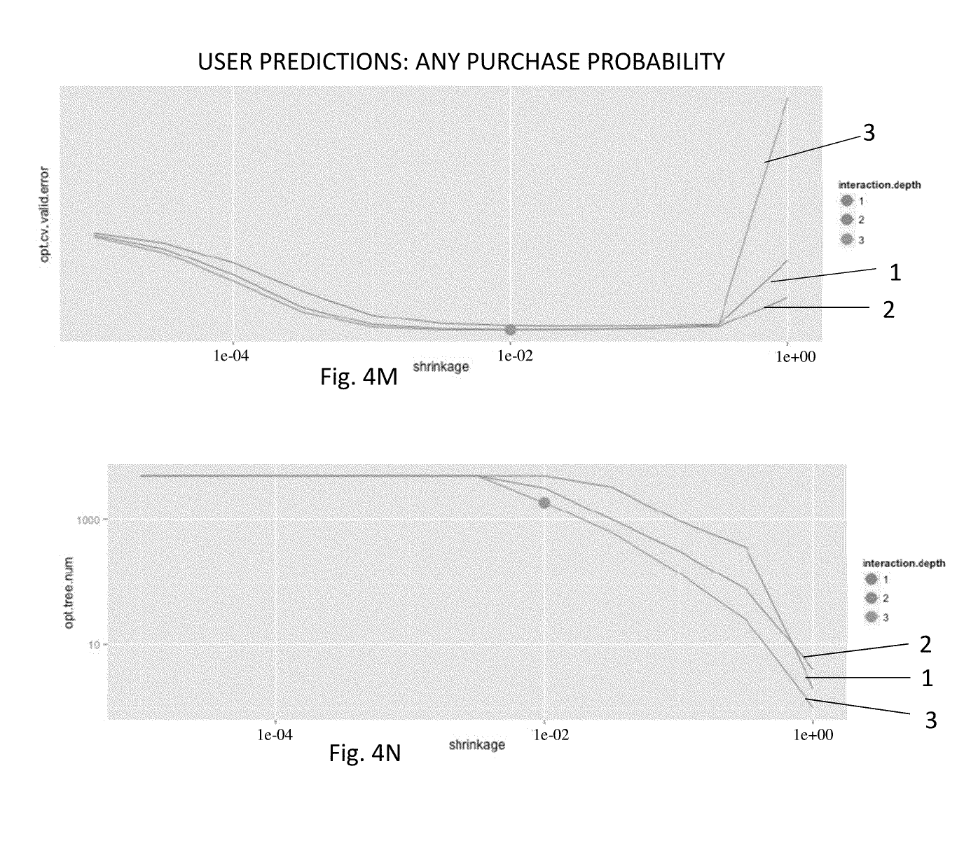

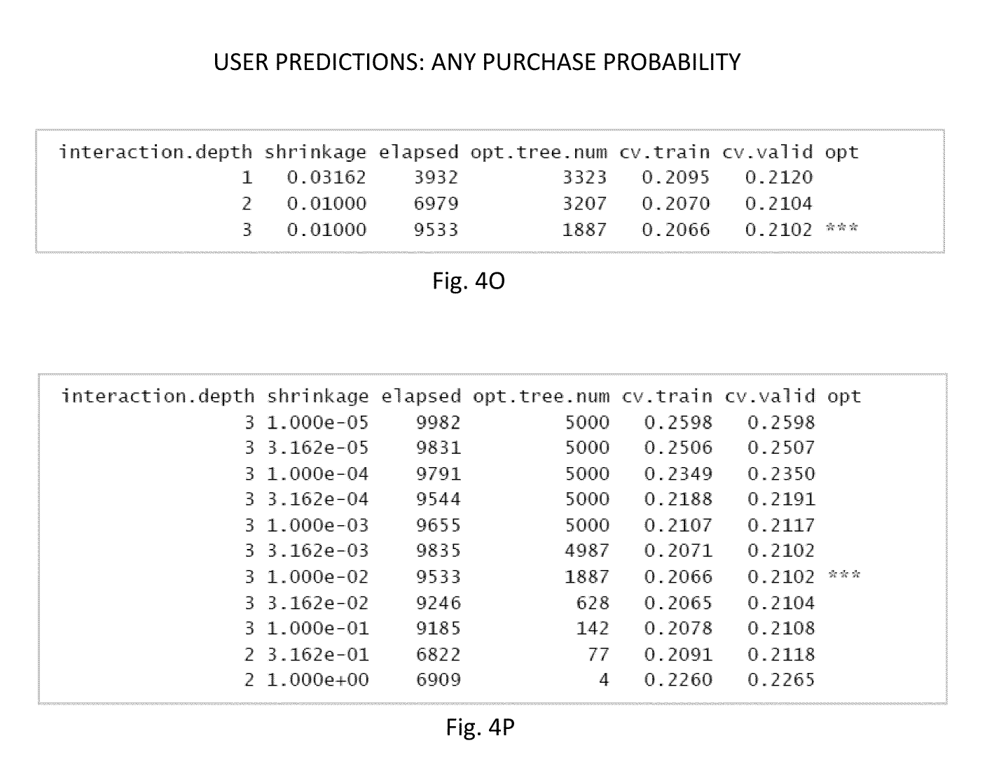

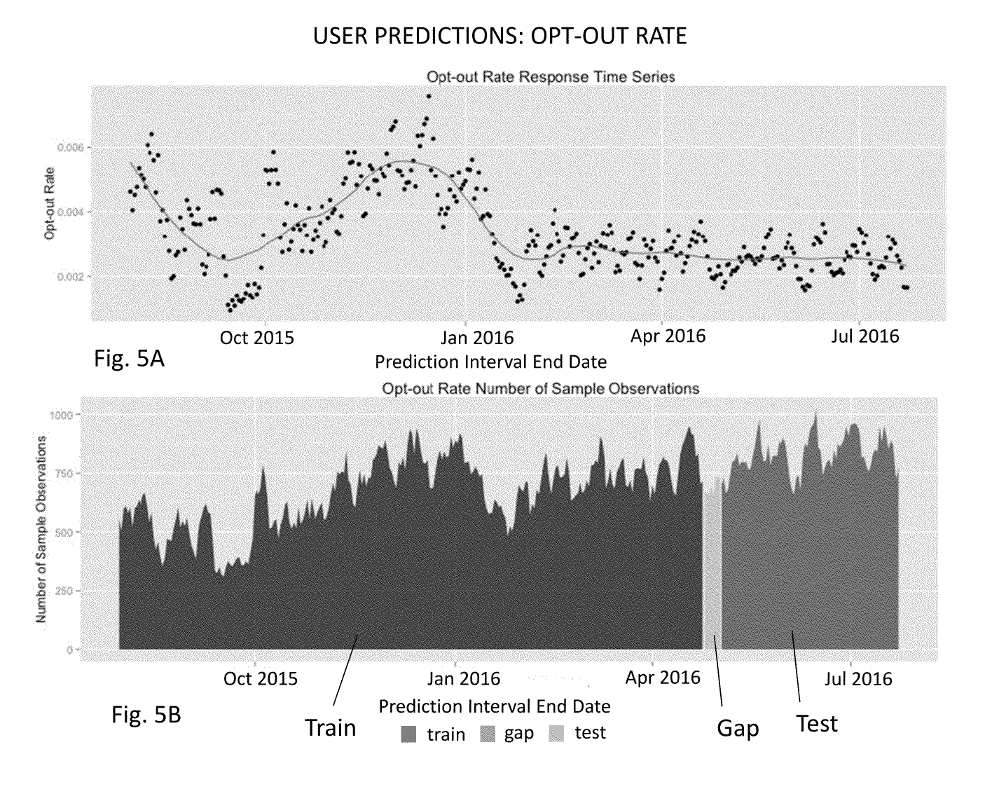

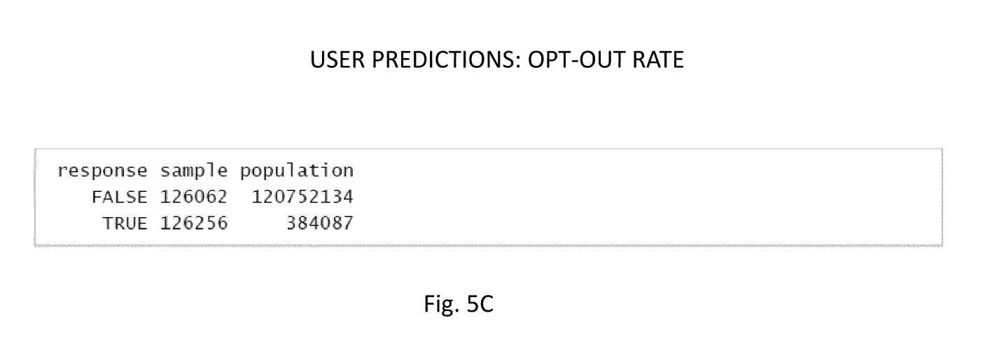

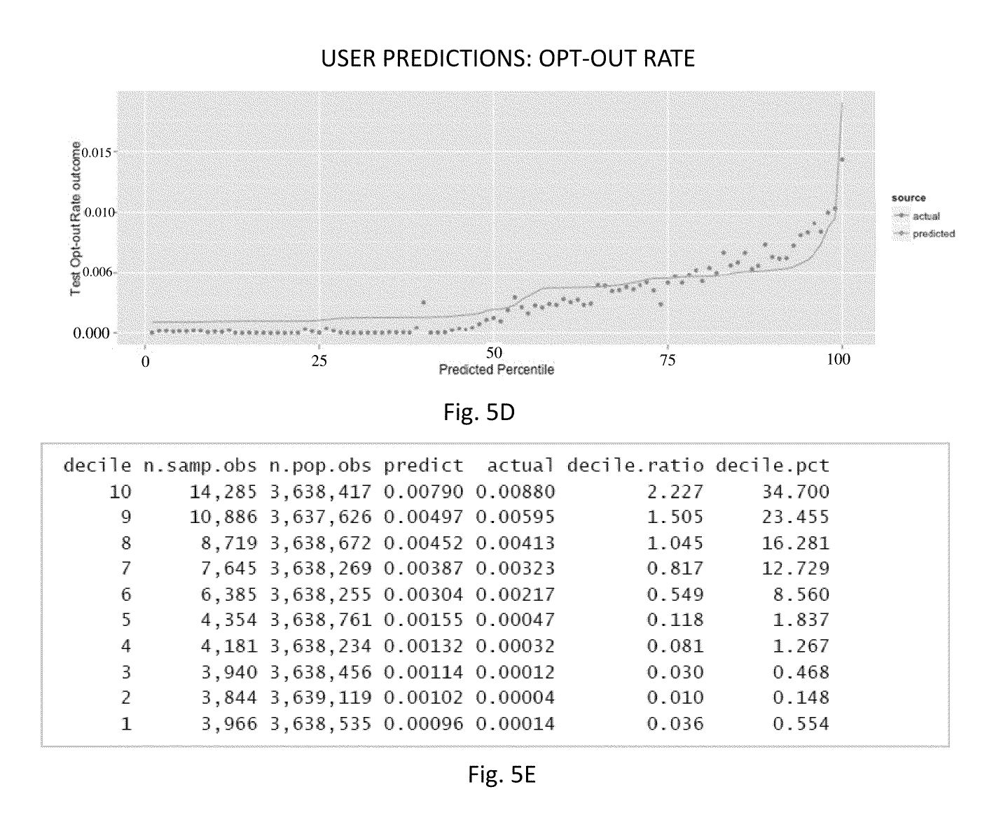

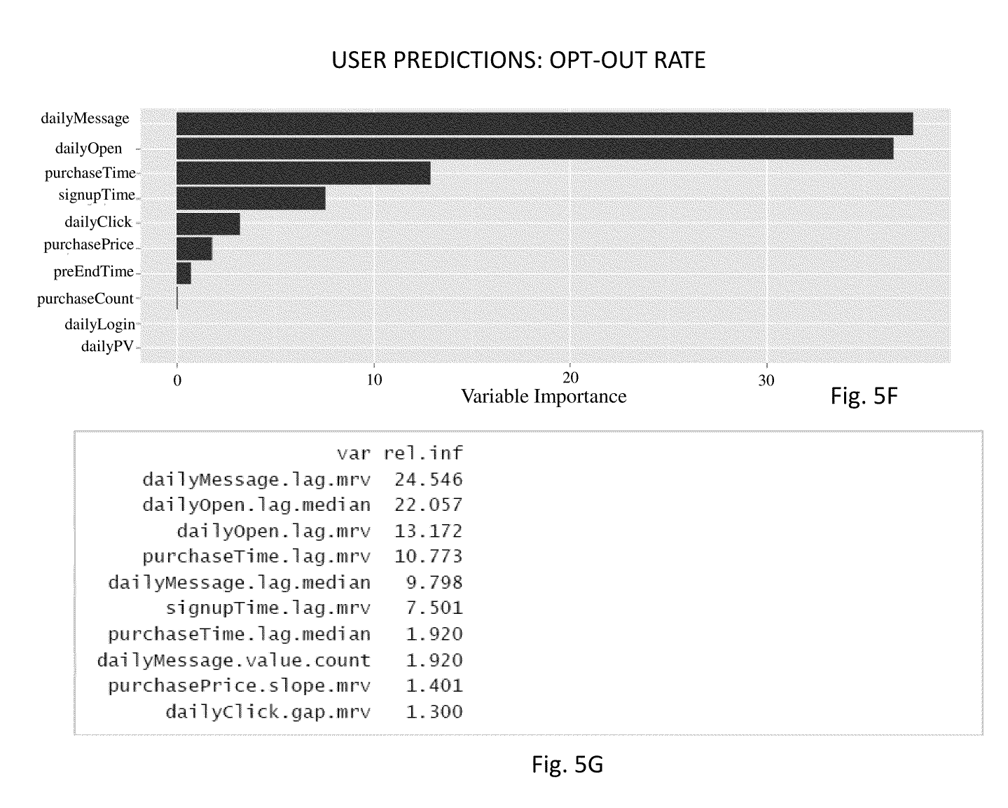

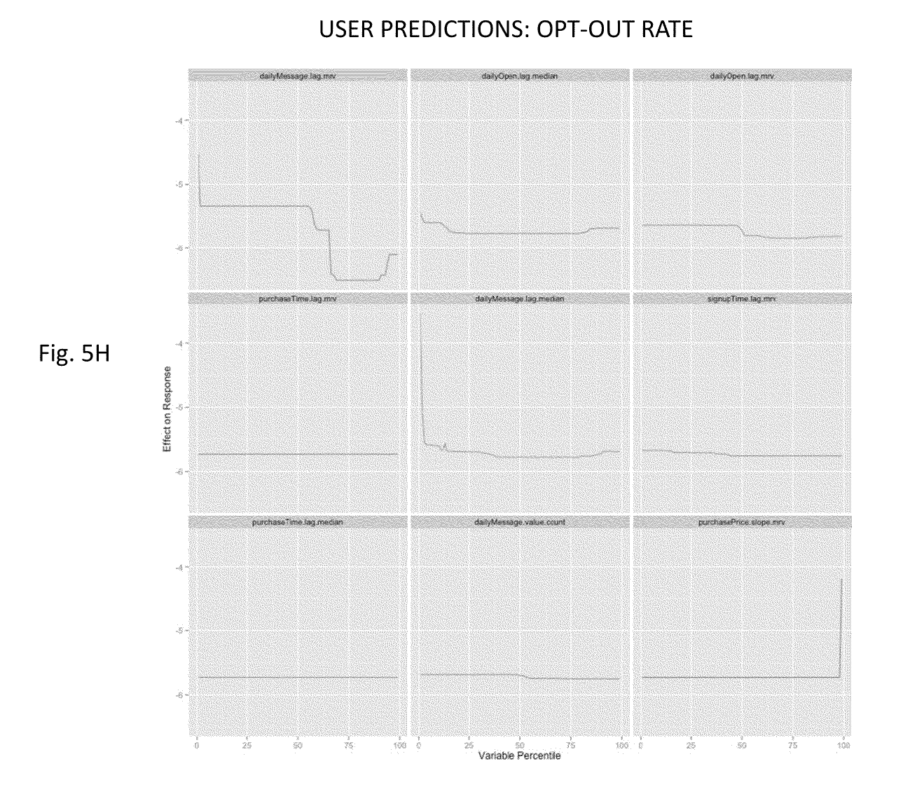

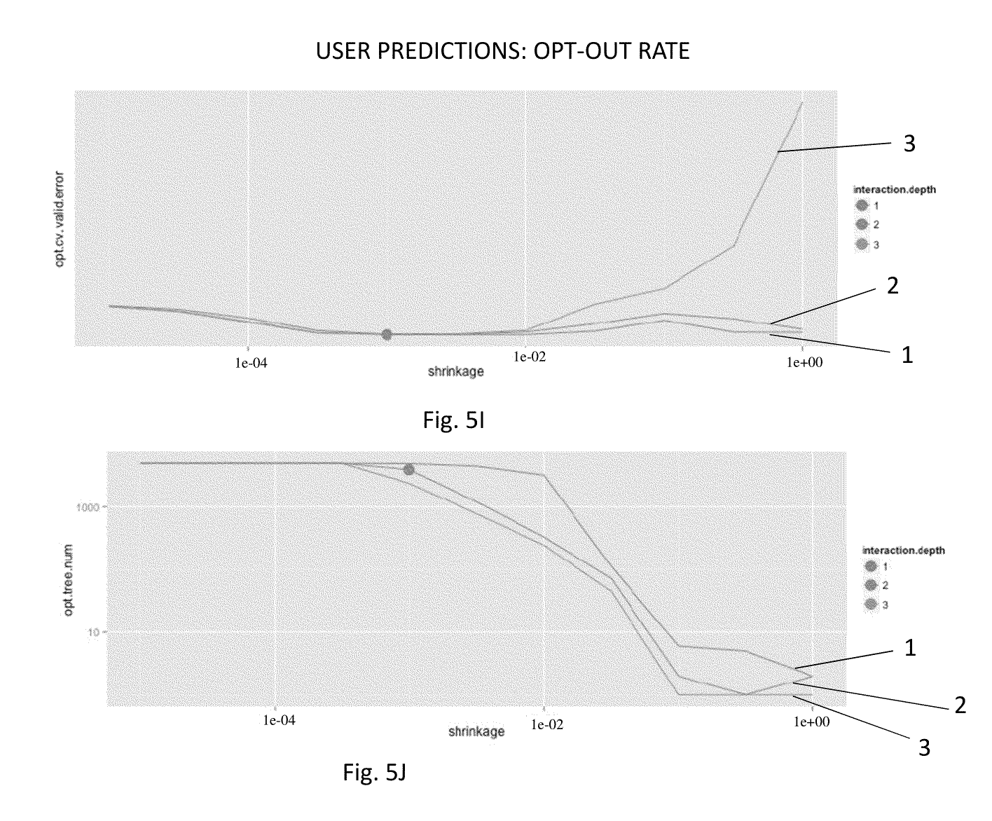

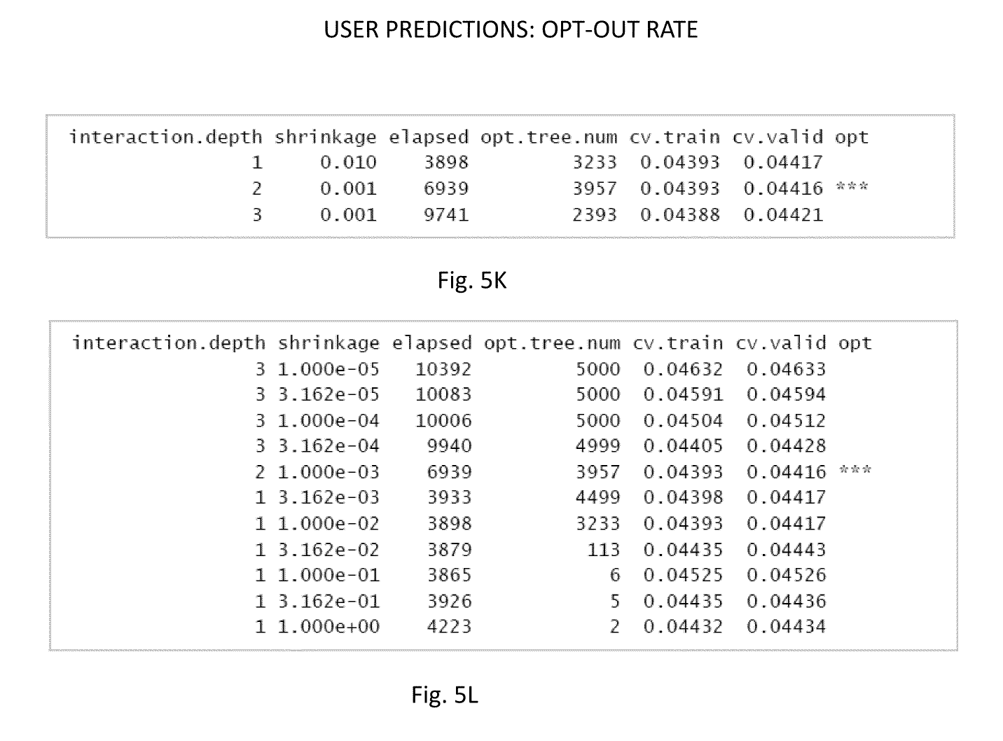

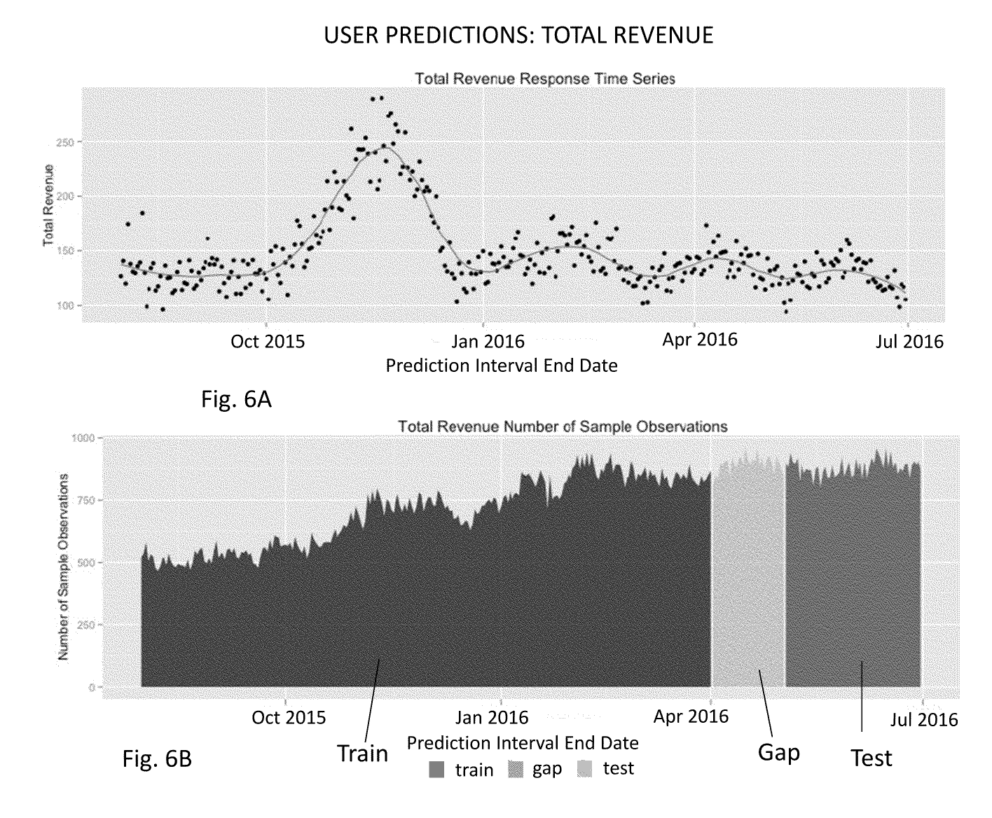

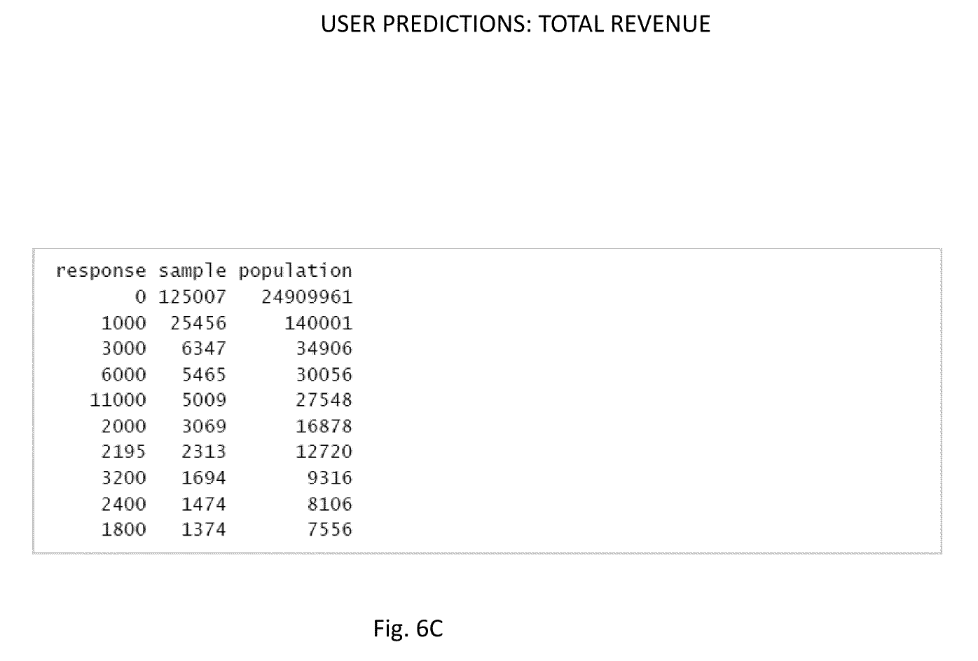

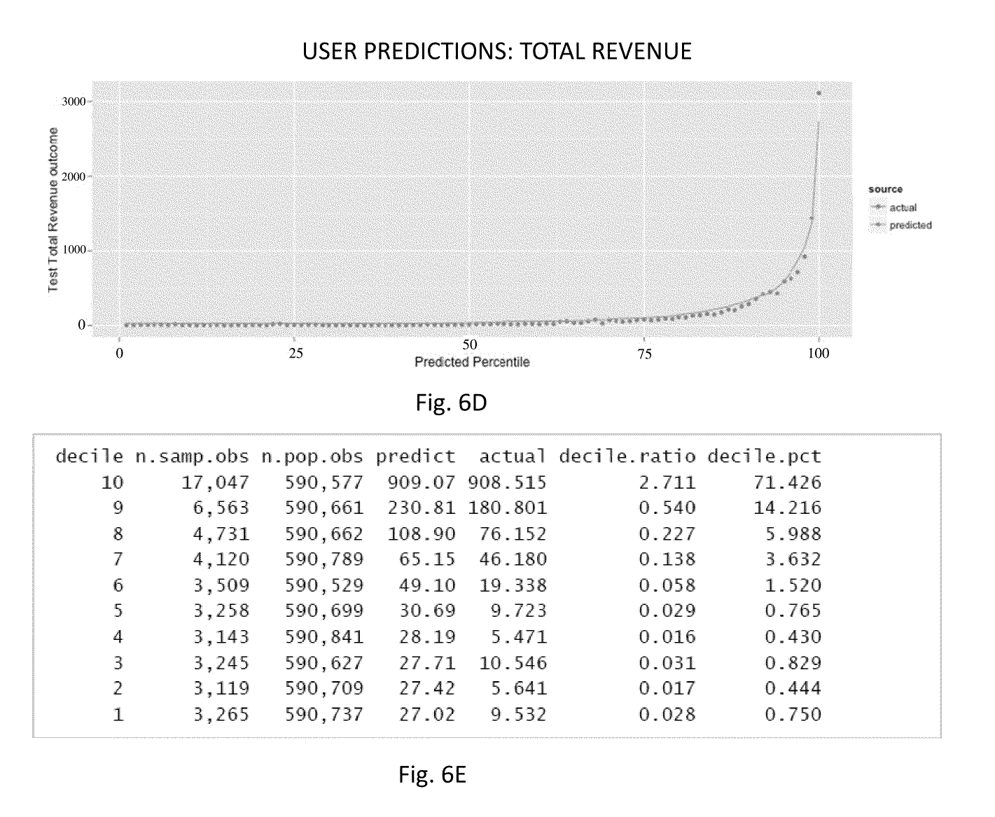

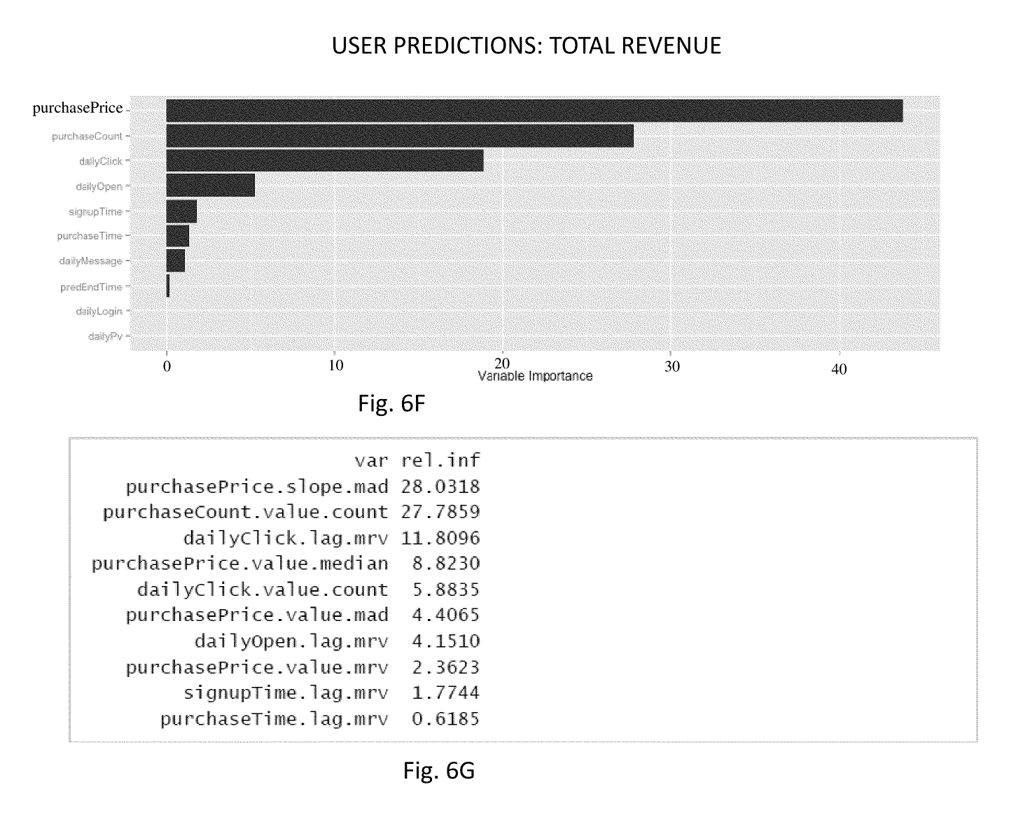

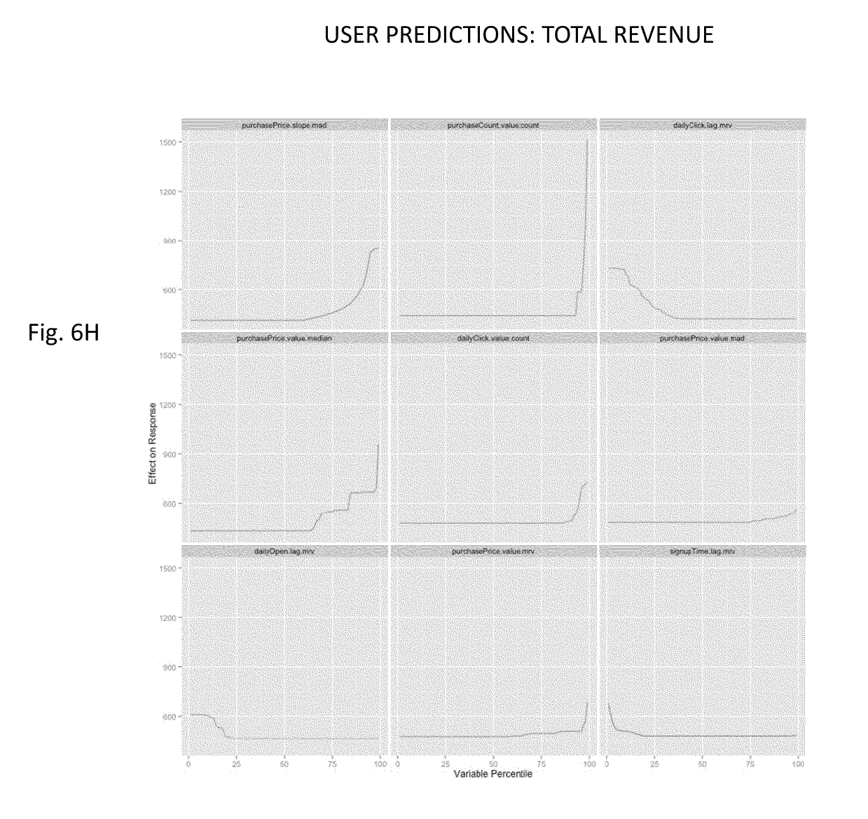

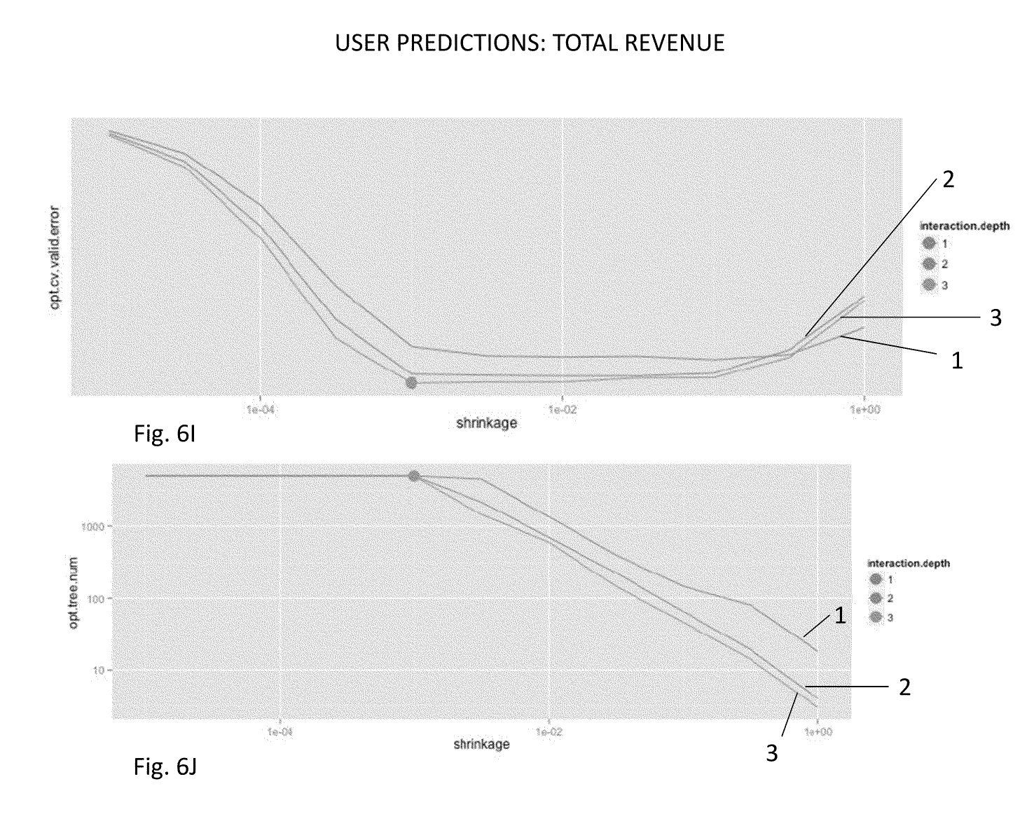

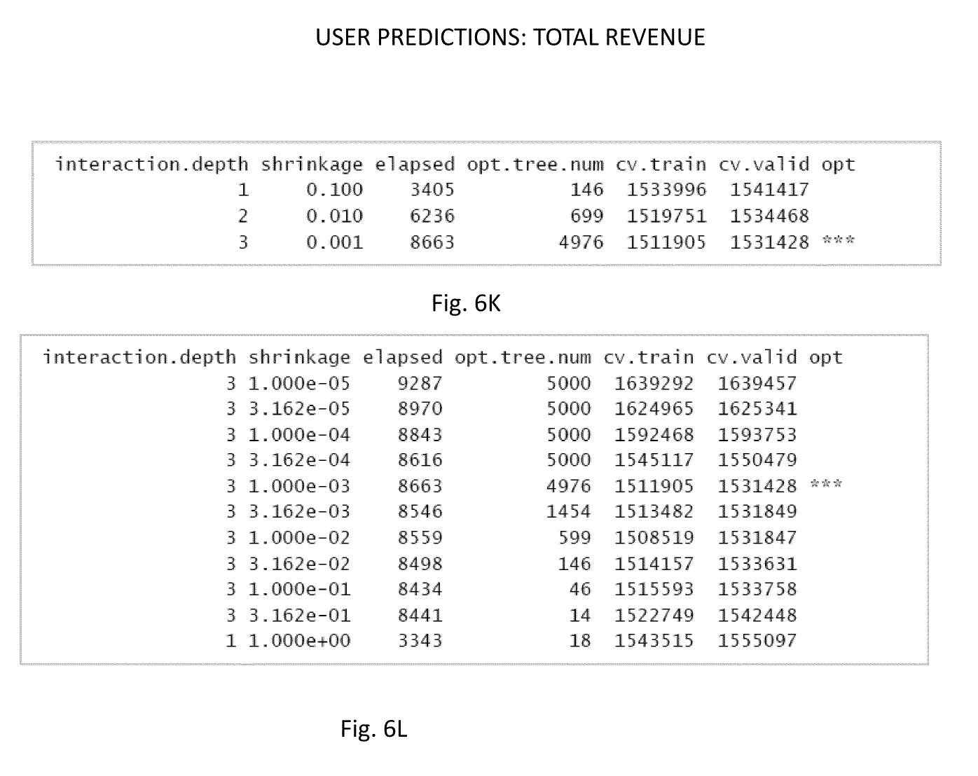

FIGS. 4A-6L identify example data, data modeling, visualizations and resulting predictions associated with purchase probability (FIGS. 4A-4P), opting-out probability (FIGS. 5A-5L), and revenue earning (FIGS. 6A-6L). In one or more implementations, kinds of predictions to be made can be selected in a graphical user interface (“GUI”) via a respective screen control (e.g., a drop-down list, checkbox, radio button, or the like), and various information relating to Mean, Median, Total (e.g., the sum of all values) and Users (e.g., number of users 306 within a respective user segment) can be displayed substantially automatically, such as in response to a “mouse-over” or other GUI event.

FIG. 4A illustrates an example data entry display screen that includes a graph of information associated with predicted impressions from one day earlier (“yesterday”) and from one week earlier. In the example implementation shown in FIG. 4A, a drop-down list is provided for a client 304 to select from impressions, clicks, click rates, purchases, conversion rates, revenue and revenue/per thousand impressions (“revenue/M”). In one or more implementations, a usable formula equals Revenue Dollar Amount/Impressions/1,000.

FIG. 4B illustrates an example graph of predicted information and includes selectable ranges in which k-Tiles can be displayed, as well as mean and median values. Furthermore, inflection points are represented and corresponding user 306 segments 452A, 452B and 452C, as well as corresponding changes in slope.

In one or more implementations, one or more APIs are used to import (“ingest”) data, such as formatted in a JSON data file. An example data source formatted in JavaScript Object Notation (“JSON”) is illustrated in FIG. 4C. The predictions in the example are labeled “openrate_7” and “aov_7.” While the inflection points are the “segments,” the bounds of are defined by the “start” and “end” values (the values are equivalent to percentiles, 355=35.5% and 454=45.4%). Further and with reference to the example JSON data file shown in FIG. 4C, the numbers “1”, “2”, etc. represent a subset of the 1000 total k-tile values. The prediction openrate_7 does not have a “total” value because it is a rate, not a hard number, and as such does not have a sum value.

With reference to FIGS. 4D-4P, a sample size (e.g., 250,000) of observations (user response intervals) is used, and each observation corresponds to observing a user for an interval of 30 days to measure the response (e.g., any purchase probability). Over this time period, the mean response (any purchase probability) was 0.027. This varied over time in accordance with the distribution shown in FIG. 4D. With regard to FIGS. 4D and 4E, 252,216 sample observations are used to build the predictive models, which were split into training and testing data. The test data regarded the most recent time period, and a gap period in-between reflects how the models are to be used in production. The time-series of observations is represented in FIG. 4E. FIG. 4F is a table that identifies the top observed response values, with the population column being an estimate based on the sample.

FIG. 4G graphically represents predicted results for a test set. Models used for determining the predictions were evaluated on the “held-out” test data from the most recent time period. For each user, a prediction was made and then an observation is made during the held-out period to identify what actually happened. Users are then sorted, from the lowest predicted outcome to the highest, and the users are “binned” into percentiles (or deciles), and the average prediction and average actual outcome are predicted. The models are shown to be performing accurately if the actual outcomes (dots) coincides with the predicted outcomes (line). The graphic representation shown in FIG. 4G is for a percentile (users are sorted into 100 bins) analysis.

FIG. 4H is a table showing detailed statistics for the deciles. In particular, this table in FIG. 4H shows that the top decile captures % of the actual response (Any Purchase Probability) outcomes.

FIG. 4I graphically represents the significance of one or more respective variables. In order to better understand how a model works, the importance of the variables used as predictors are plotted. This importance can be computed from the gradient boosted decision tree models by evaluating how much an error is reduced every time a tree “splits” on each variable. FIG. 4H shows the variable importance for each time-series used (summed over multiple predictors derived from the time series). FIG. 4J shows a table that identifies the top individual predictors derived from the time series data.

FIG. 4K graphically represents the effects of one or more respective variables. As shown in FIG. 4K, the effect that each of the top predictors has on the response is plotted. This is computed by integrating out other effects in the model, besides a variable of interest. The plot in FIG. 4K shows on the x-axis the percentiles of the predictor (they have a wide variety of distributions), and on the y-axis the impact that predictor is having on the response (on an additive scale—e.g., log-odds for probability outcomes).

FIG. 4L graphically represents hyper-parameter grid search results of one or more gradient boosting machine models. As shown in FIG. 4L, gradient boosting machine (GBM) models are used, which have a few parameters that may need to be tuned. Rather than tune such model(s) manually, which would preclude being scalable across many outcomes and clients 304, a grid search of possible values is conducted and the parameters that optimize out of sample error performance are selected. In one or more implementations, tuning the interaction depth (e.g., how deep the trees go) and the shrinkage rate (the rate at which the models learn) is conducted. Additionally, the number of trees used (equivalent to early stopping) is tuned. The graphical representation in FIG. 4L shows the out of sample error versus the primary grid search parameters. FIG. 4M shows the optimal number of trees selected in an example implementation. FIG. 4N shows a table that identifies the optimal models by interaction depth. FIGS. 4O and 4P show a table that identifies example optimal models by shrinkage.

With reference to FIGS. 5A-5L, a sample size of 250,000 observations (user response intervals) is used, and each observation corresponds to observing a user for an interval of 7 days to measure the response (e.g., Opt-Out Rate). Over this time period, the mean response (opt-out) was 0.0032. This varied over time in accordance with the distribution shown in FIG. 5A. With regard to FIG. 5A and FIG. 5B, exactly 252,318 sample observations are used to build the predictive models. They were split into training and testing data, with the test data coming from the most recent time period, and a gap period in-between reflects how the models are to be used in production. The time-series of observations is represented in FIG. 5B. FIG. 5C is a table that identifies the top observed response values, with the population column being an estimate based on the sample.

FIG. 5D graphically represents predicted results for a test set. Models used for determining the predictions were evaluated on the “held-out” test data from the most recent time period. For each user, a prediction is made and then an observation is made during the held-out period to identify what actually happened. Users are then sorted, from the lowest predicted outcome to the highest, and the users are “binned” into percentiles (or deciles), and the average prediction and average actual outcome are predicted. The models are shown to be performing accurately if the actual outcomes (dots) coincides with the predicted outcomes (line). The graphic representation shown in FIG. 5D is for a percentile (users are sorted into 100 bins) analysis.

FIG. 5E is a table showing detailed statistics for the deciles. In particular, this table in FIG. 5E shows that the top decile captures % of the actual response (Opt-out Rate) outcomes.

FIG. 5F graphically represents the significance of one or more respective variables. In order to better understand how a model works, the importance of the variables used as predictors are plotted. This importance can be computed from the gradient boosted decision tree models by evaluating how much an error is reduced every time a tree “splits” on each variable. FIG. 5F shows the variable importance for each time-series used (summed over multiple predictors derived from the time series). FIG. 5G shows a table that identifies the top individual predictors derived from the time series data.

FIG. 5H graphically represents the effects of one or more respective variables. As shown in FIG. 5H, the effect that each of the top predictors has on the response is plotted. This is computed by integrating out other effects in the model, besides a variable of interest. The plot in FIG. 5H shows on the x-axis the percentiles of the predictor (they have a wide variety of distributions), and on the y-axis the impact that predictor is having on the response (on an additive scale—e.g., log-odds for probability outcomes).

FIG. 5I graphically represents hyper-parameter grid search results of one or more gradient boosting machine models. As shown in FIG. 5I, gradient boosting machine (GBM) models are used, which have a few parameters that may need to be tuned. Rather than tune such model(s) manually, which would preclude being scalable across many outcomes and clients 304, a grid search of possible values is conducted and the parameters that optimize out of sample error performance are selected. In one or more implementations, tuning the interaction depth (e.g., how deep the trees go) and the shrinkage rate (the rate at which the models learn) is conducted. Additionally, the number of trees used (equivalent to early stopping) is tuned. The graphical representation in FIG. 5I shows the out of sample error versus the primary grid search parameters. FIG. 5J shows the optimal number of trees selected. FIG. 5K shows a table that identifies the optimal models by interaction depth. FIG. 5L shows a table that identifies optimal models by shrinkage.

With reference to FIGS. 6A-6L, a sample size of 250,000 observations (user response intervals) is used, and each observation corresponds to observing a user for an interval of 30 days to measure the response (e.g., Total Revenue). Over this time period, the mean response (total revenue) was 145.2657. This varied over time in accordance with the distribution shown in FIG. 6A. With regard to FIG. 6A and FIG. 6B, exactly 251,391 sample observations are used to build the predictive models. They were split into training and testing data, with the test data coming from the most recent time period, and a gap period in-between reflects how the models are to be used in production. The time-series of observations is represented in FIG. 6B. FIG. 6C is a table that identifies the top observed response values, with the population column being an estimate based on the sample.

FIG. 6D graphically represents predicted results for a test set. Models used for determining the predictions were evaluated on the “held-out” test data from the most recent time period. For each user, a prediction is made and then an observation is made during the held-out period to identify what actually happened. Users are then sorted, from the lowest predicted outcome to the highest, and the users are “binned” into percentiles (or deciles), and the average prediction and average actual outcome are predicted. The models are shown to be performing accurately if the actual outcomes (dots) coincides with the predicted outcomes (line). The graphic representation shown in FIG. 6D is for a percentile (users are sorted into 100 bins) analysis.

FIG. 6E is a table showing detailed statistics for the deciles. In particular, this table in FIG. 6E shows that the top decile captures % of the actual response (Total Revenue) outcomes.

FIG. 6F graphically represents the significance of one or more respective variables. In order to better understand how a model works, the importance of the variables used as predictors are plotted. This importance can be computed from the gradient boosted decision tree models by evaluating how much an error is reduced every time a tree “splits” on each variable. FIG. 6F shows the variable importance for each time-series used (summed over multiple predictors derived from the time series). FIG. 6G shows a table that identifies the top individual predictors derived from the time series data.

FIG. 6H graphically represents the effects of one or more respective variables. As shown in FIG. 6H, the effect that each of the top predictors has on the response is plotted. This is computed by integrating out other effects in the model, besides a variable of interest. The plot in FIG. 6H shows on the x-axis the percentiles of the predictor (they have a wide variety of distributions), and on the y-axis the impact that predictor is having on the response (on an additive scale—e.g., log-odds for probability outcomes).

FIG. 6I graphically represents hyper-parameter grid search results of one or more gradient boosting machine models. As shown in FIG. 6I, gradient boosting machine (GBM) models are used, which have a few parameters that may need to be tuned. Rather than tune such model(s) manually, which would preclude being scalable across many outcomes and clients 304, a grid search of possible values is conducted and the parameters that optimize out of sample error performance are selected. In one or more implementations, tuning the interaction depth (e.g., how deep the trees go) and the shrinkage rate (the rate at which the models learn) is conducted. Additionally, the number of trees used (equivalent to early stopping) is tuned. The graphical representation in FIG. 6I shows the out of sample error versus the primary grid search parameters. FIG. 6J shows the optimal number of trees selected. FIG. 6K shows a table that identifies the optimal models by interaction depth. FIG. 6L shows a table that identifies optimal models by shrinkage.

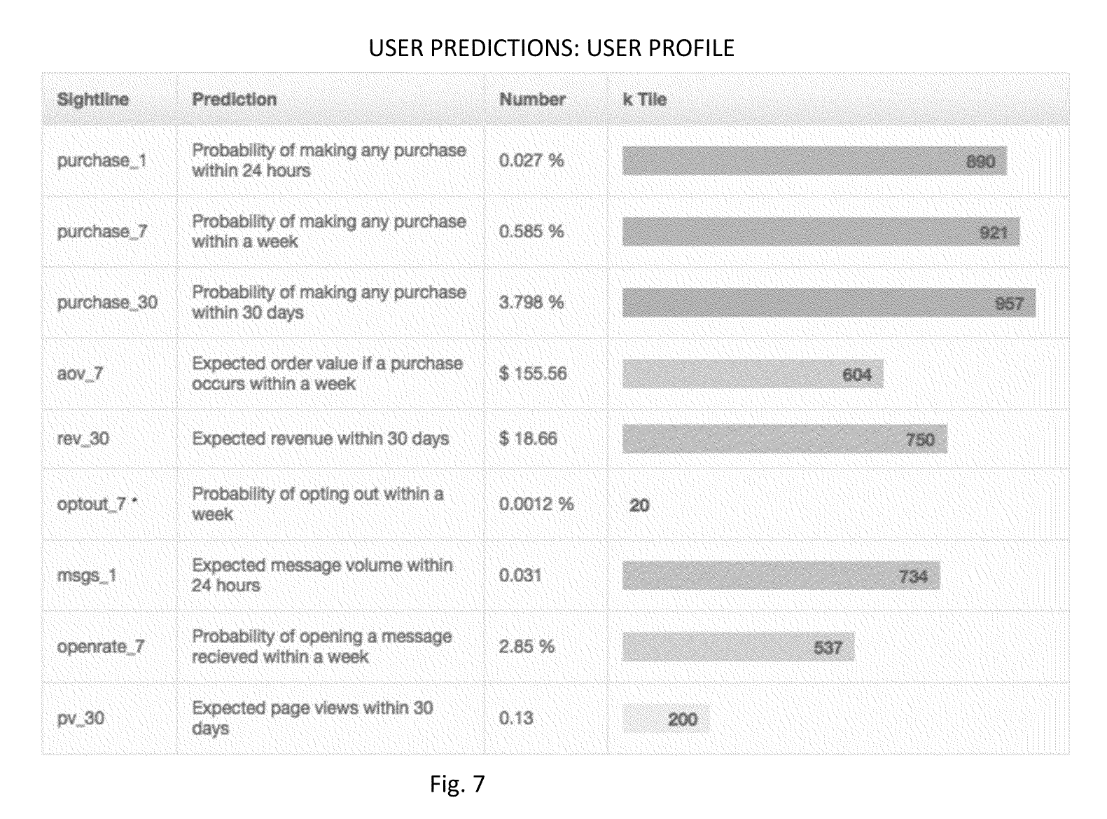

FIG. 7 illustrates a table that includes values and a simple chart that graphically represents corresponding k-Tile values associated with a plurality of predictions. For example, and as shown in FIG. 7, predictions associated with a probability of making any purchase within 24 hours, within one week, and within 30 days are shown. Further, predictions associated with an expected order value, revenue, probability of opting out, message volume, opening a message and page views within respective time periods are shown. Corresponding values, including dollar values and percentage values are similarly shown. The tables shown in FIG. 7 correspond to a lookup page for an individual user 306.

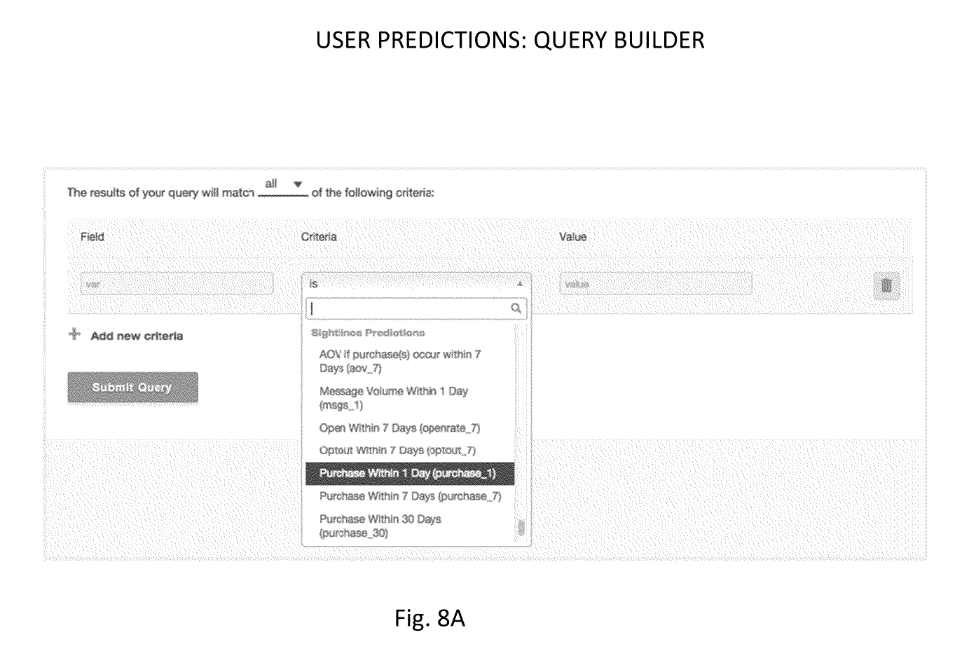

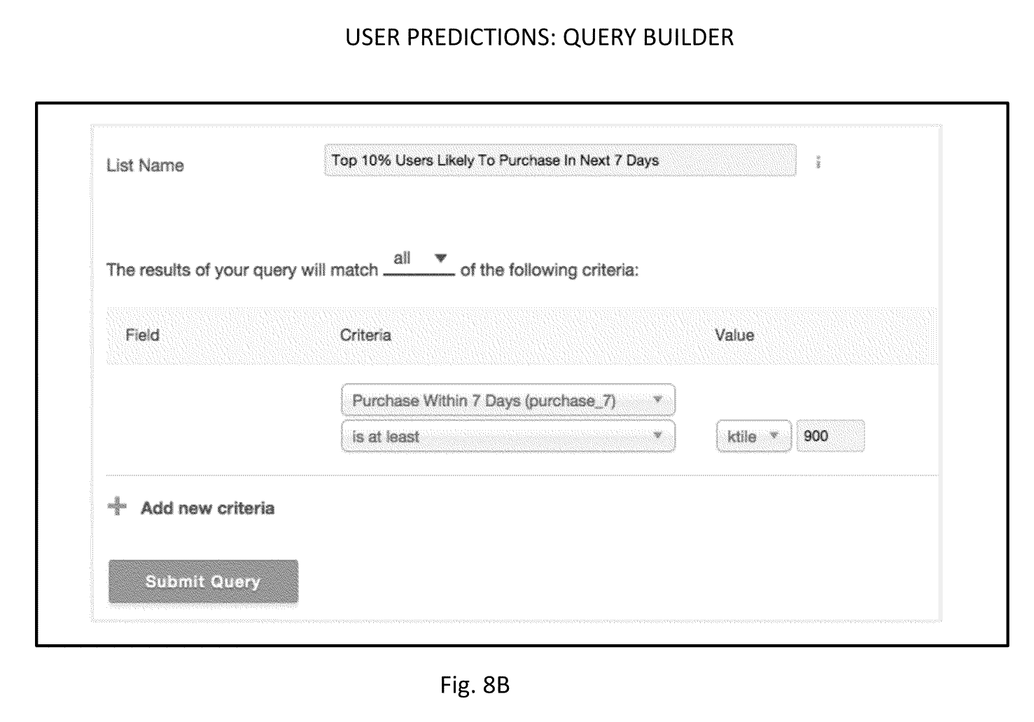

FIG. 8A illustrates an example data entry display screen that enables a client 304 to build a query using various criteria, for example, provided in one or more drop-down lists. Some or all of the criteria can be used to generate results of the query. Moreover, users can add additional criteria to refine the query in various ways. FIG. 8B illustrates another example data entry display screen that enables a client 304 to build a query using various criteria, in which the query has been saved and named, “Top 10% of Users Likely to Purchase in Next Seven Days.”

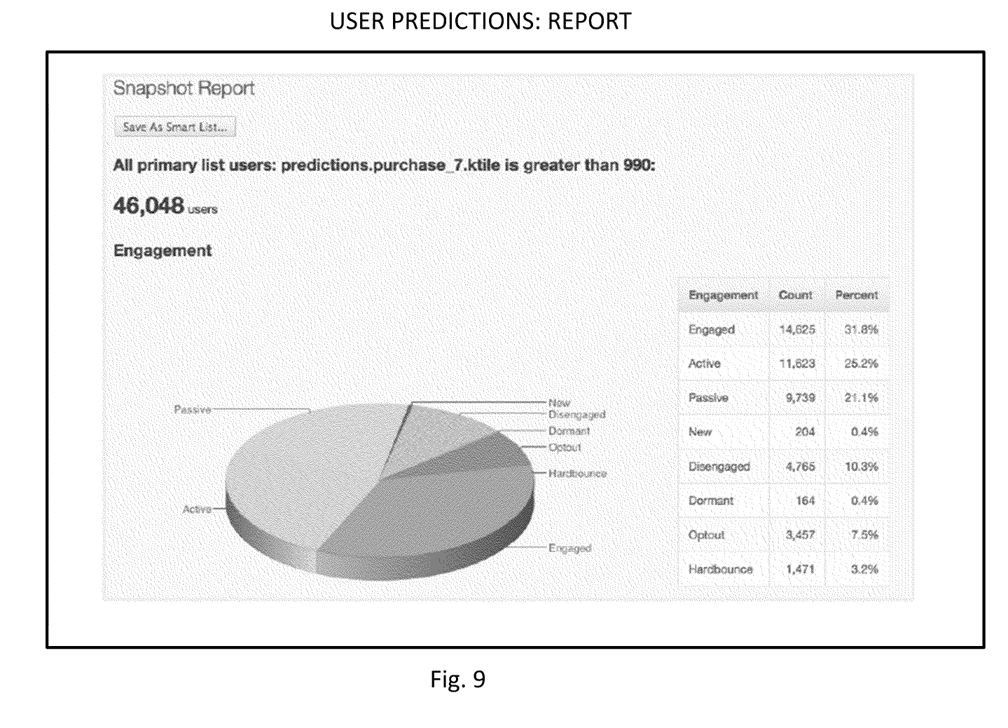

FIG. 9 illustrates an example data report that identifies the results of a query defined by a client 304 and identifies predictions of purchase where the k-Tile is greater than 990. This represents the top 1% of users were most likely to purchase in the next seven days. 46,048 users are identified in the report, and a high chart graphically identifies the users in respective groups associated with levels of engagement. For example, whether users are engaged, active, passive, new, disengaged, dormant, opt out and hardbounce and respective counts and percentage values are shown.

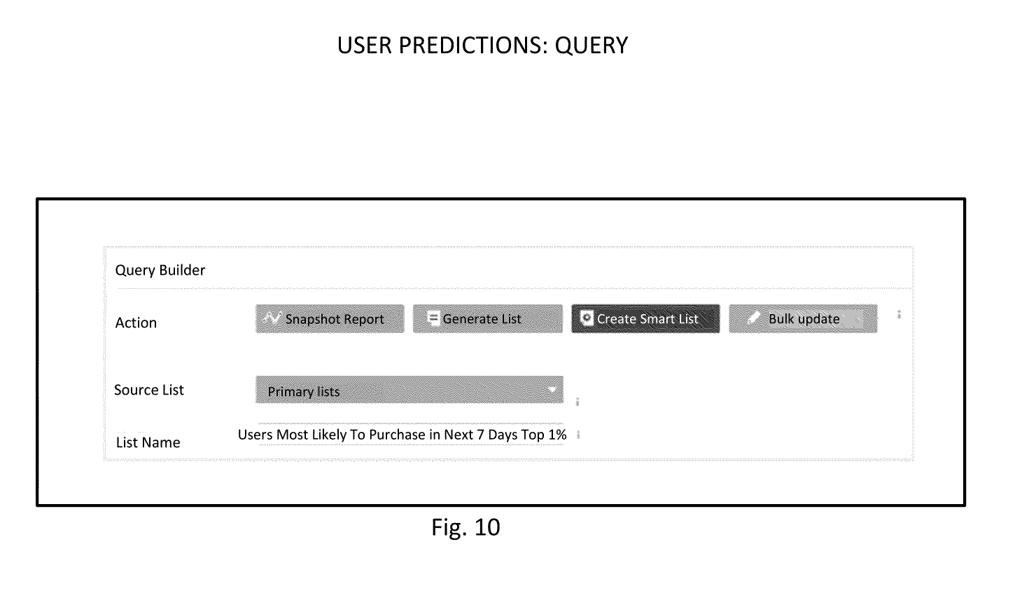

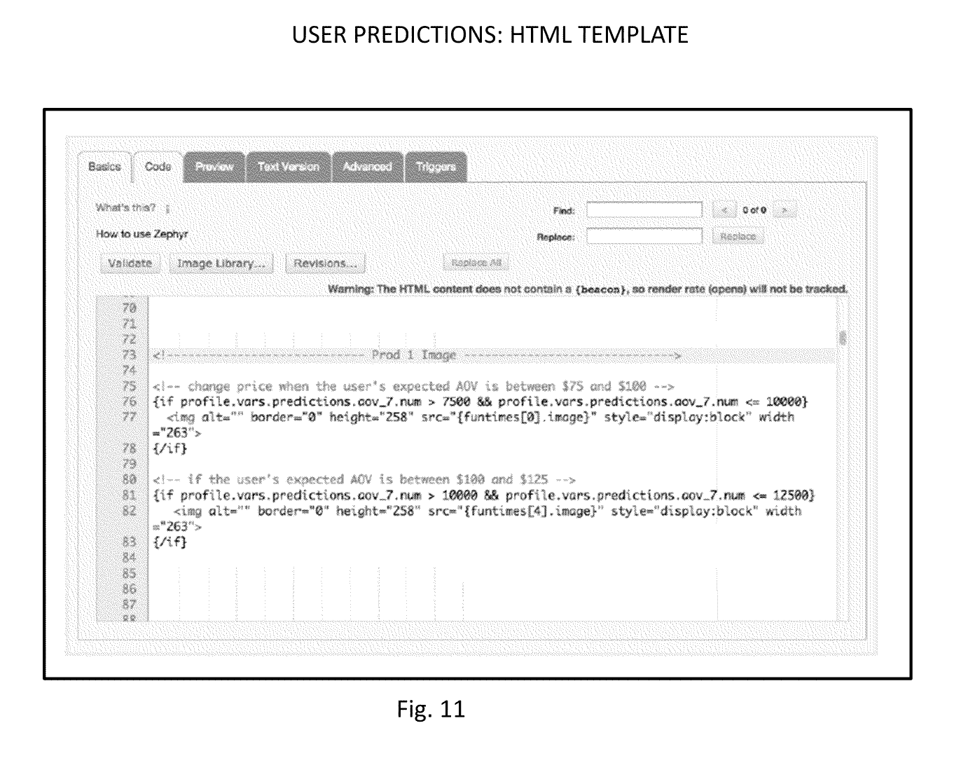

FIG. 10 illustrates example options provided with a query builder in accordance with an example implementation of the present application. Options are provided for various actions in connection with user data, including to generate snapshot reports, generating a list, create a smart list and bulk updates. FIG. 11 illustrates an example data entry display screen in which Zephyr scripting is used for utilizing predictions in accordance with an example implementation in an email template and to price discriminate is shown.

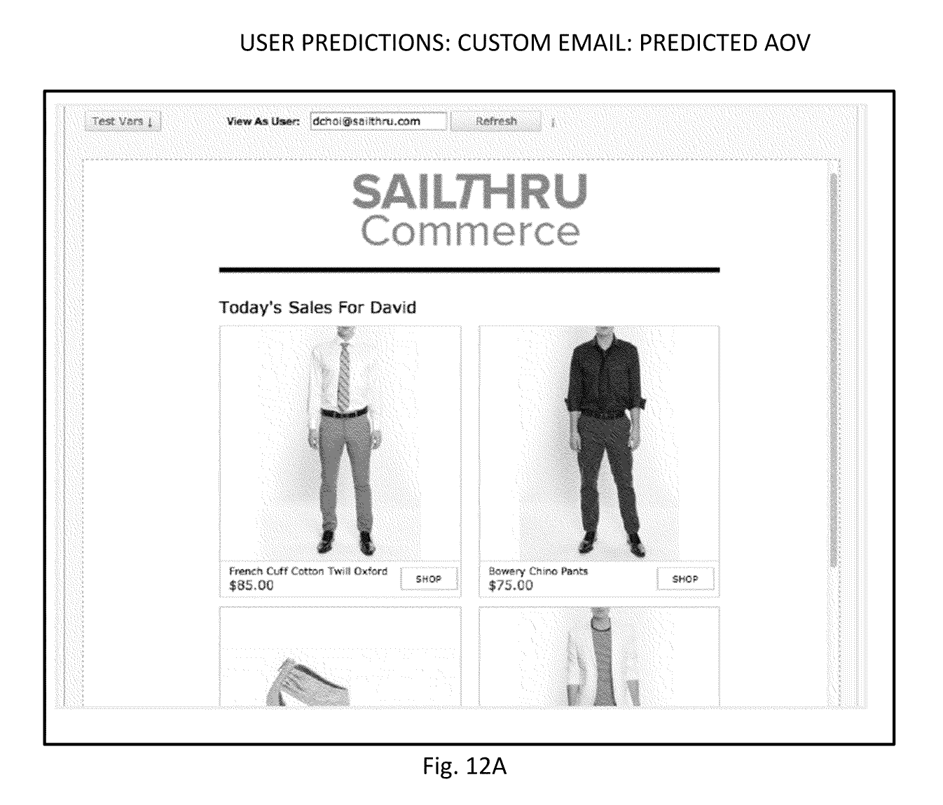

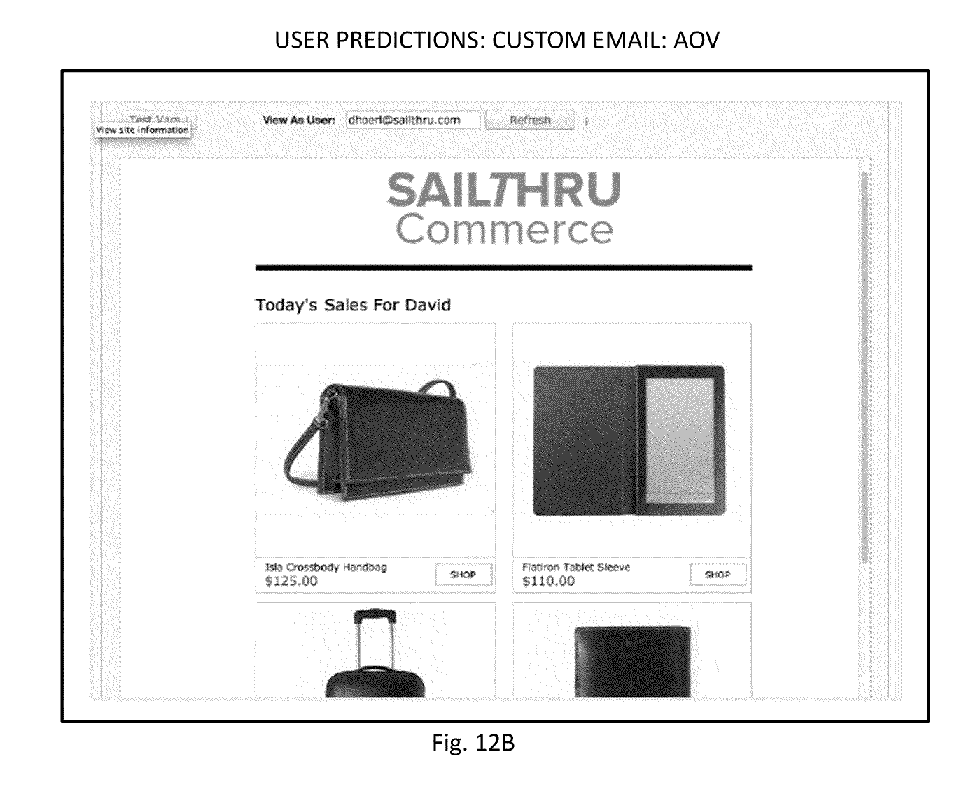

FIGS. 12A and 12B illustrate custom email messages for respective users in view of predictions made in accordance with the present application, including with regard to likelihood of a purchase of a certain amount of money (e.g., $84 and $110, respectively). As shown in FIGS. 12A and 12B, selection of product is made as a function of the values predicted to be spent, in addition or in lieu of other profile information for respective users 306.

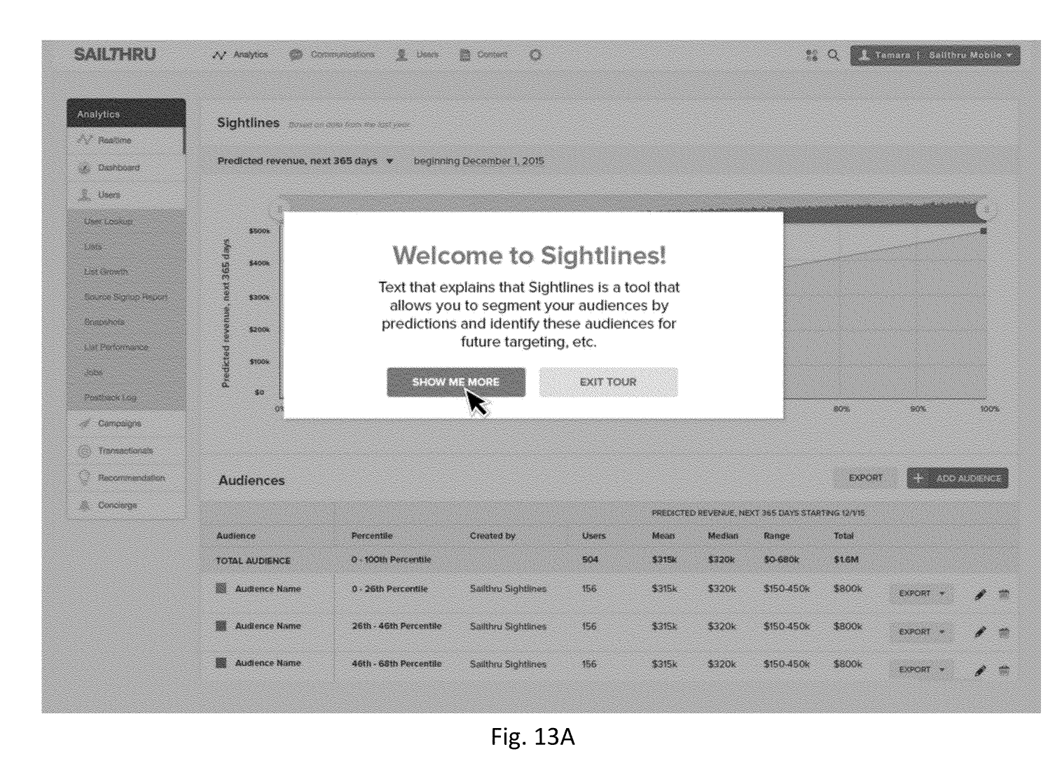

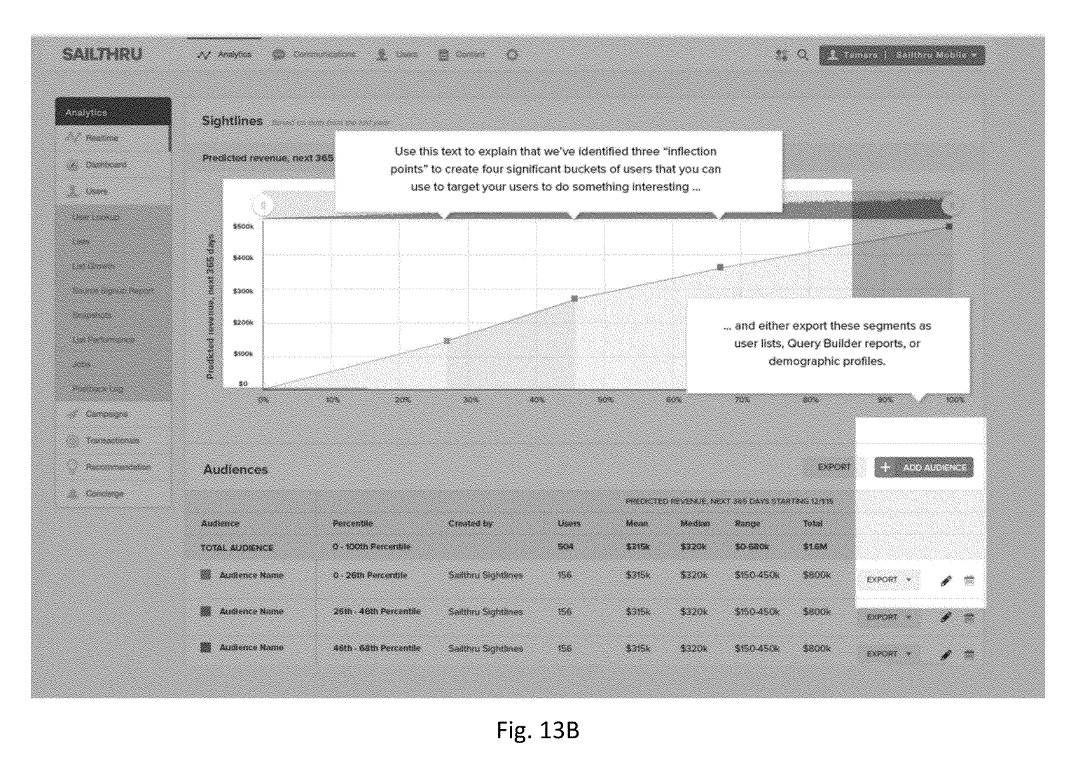

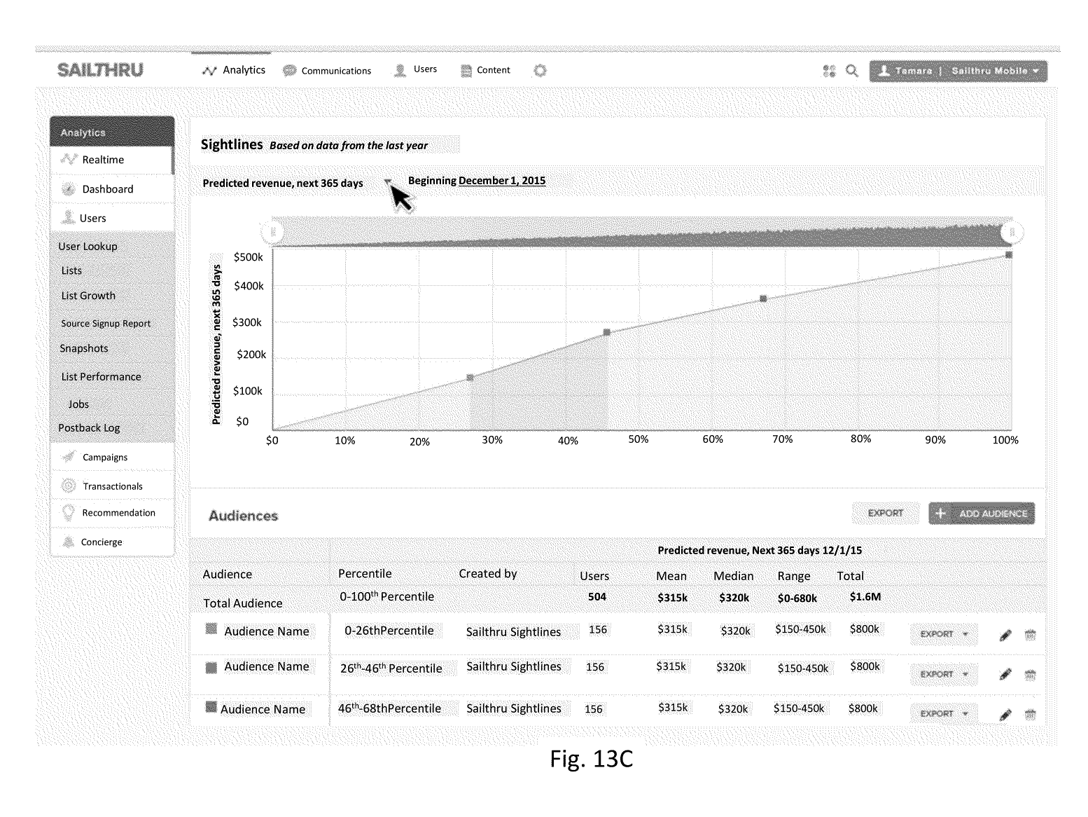

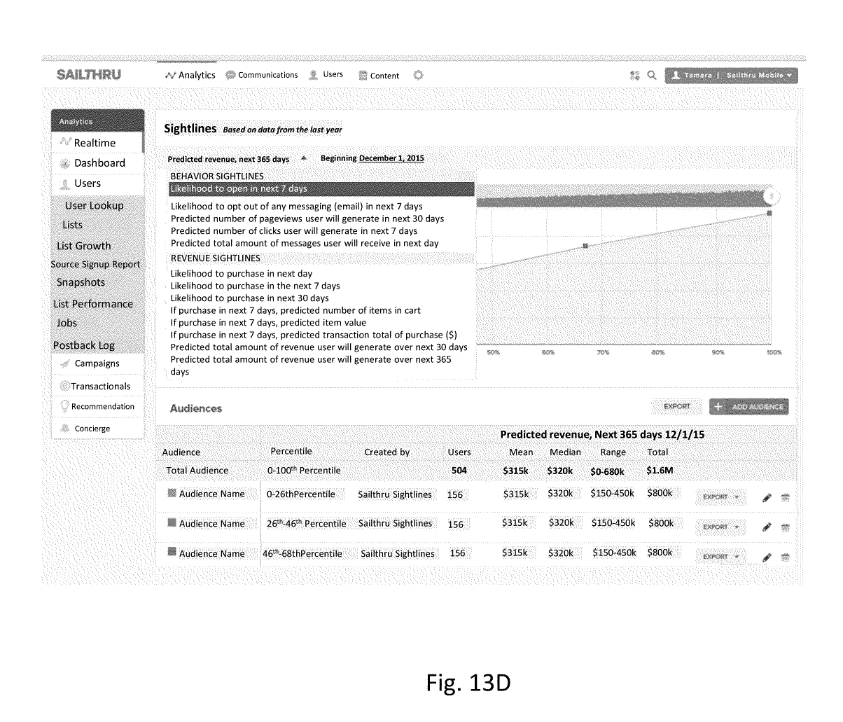

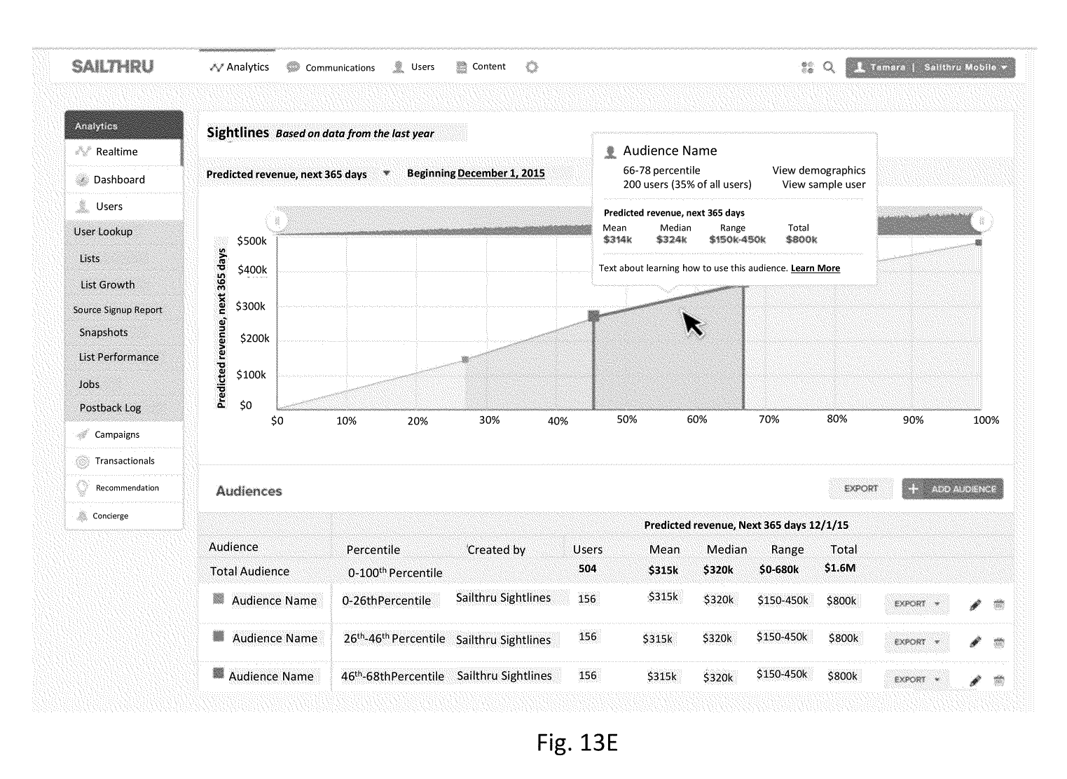

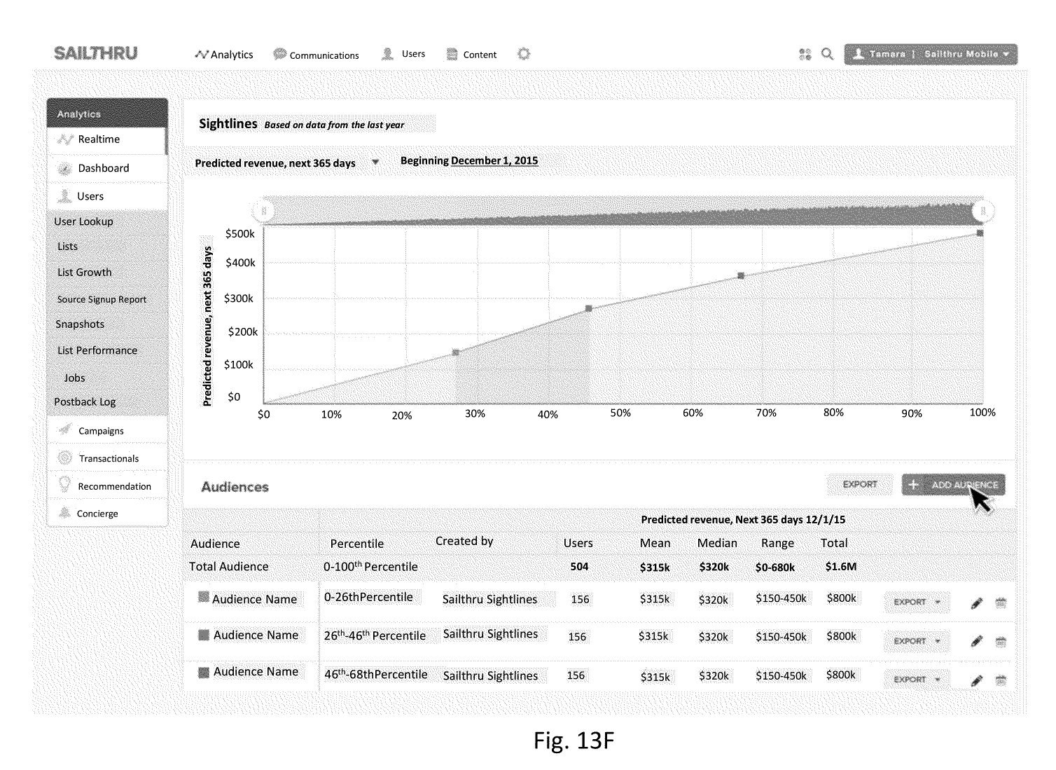

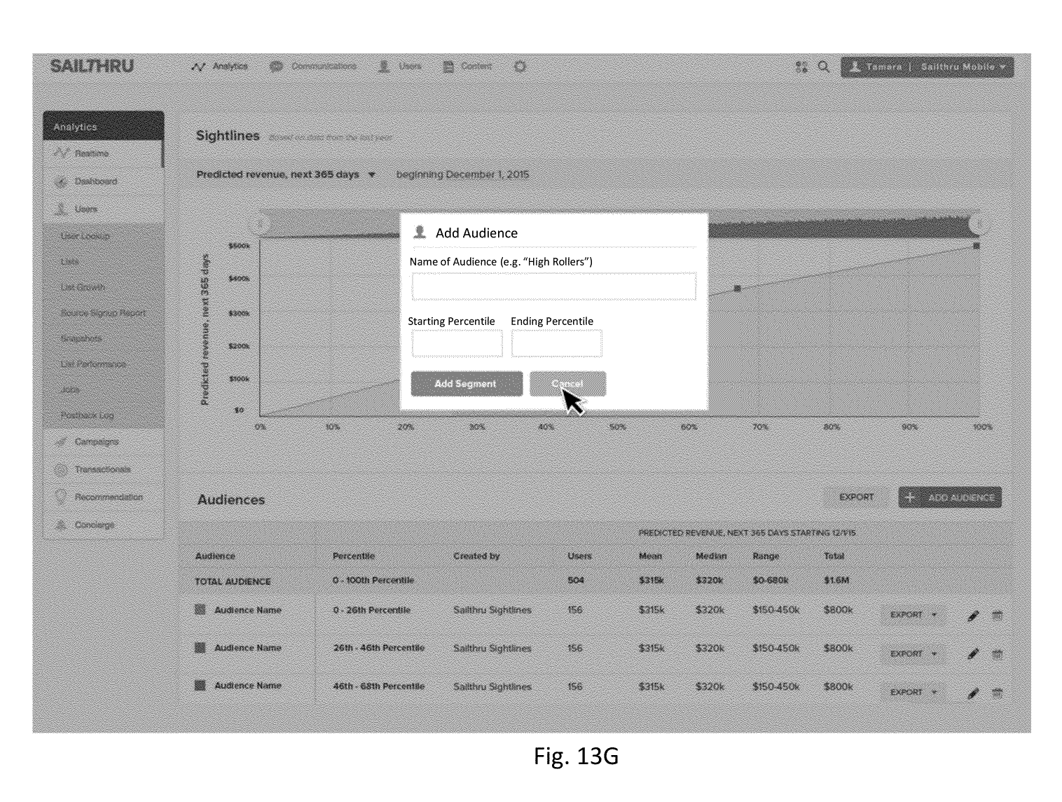

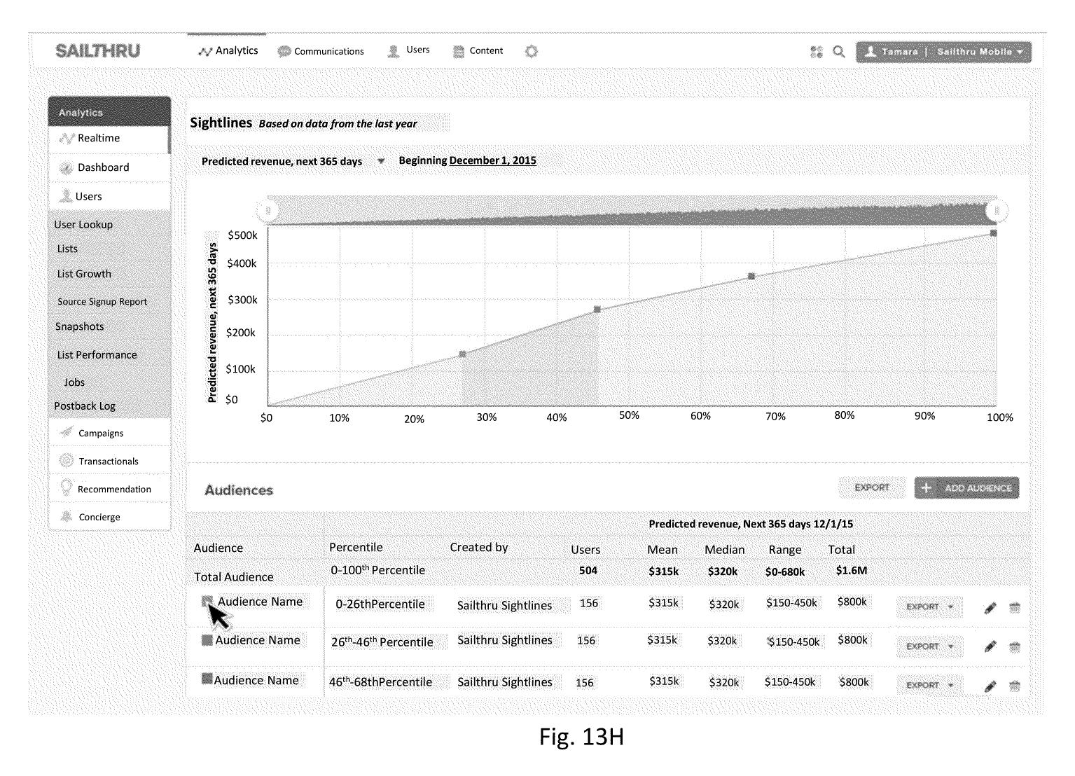

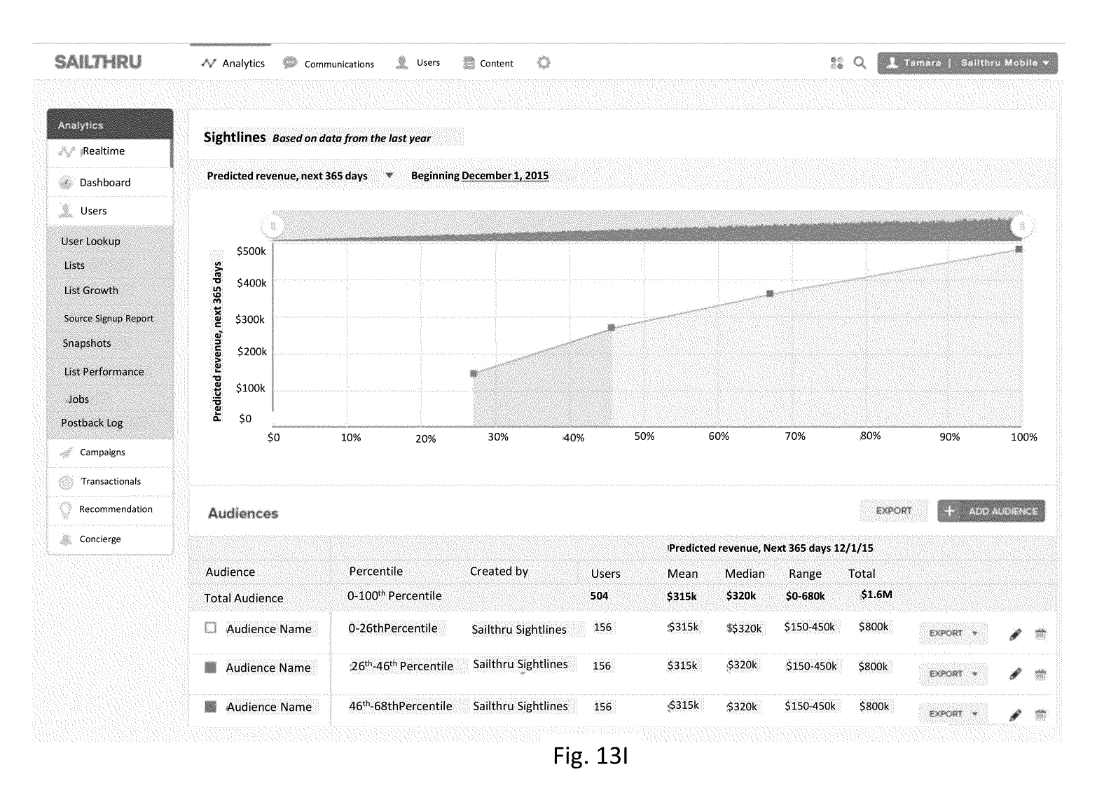

FIGS. 13A-13I illustrate example data entry display screens in accordance with a graphical user interface in an example implementation of the present patent application featuring inflection points to create segments of a user base. For example, defining three inflection points can result four segments of a user base and usable for targeting the respective groups strategically.

FIG. 13A illustrates an example welcome screen associated with a tour of an example implementation and shown and described herein, generally, as “Sightlines.” FIG. 13B illustrates a display screen associated with the tour that identifies three inflection points. Controls such as “Add Audience” can be provided for exporting the resulting four segments of the user base, such as user lists, query builder reports and demographic profiles. FIG. 13C illustrates an example Sightlines display screen and demonstrates a dropdown list graphical screen control that, when selected, enables user computing device 104 and/or information processor 102 to provide a date range for predicted revenue including a respective starting date and an amount of time therefrom (shown as 365 days). Also illustrated in FIG. 13C is a table of audiences corresponding to the respective segments (four in FIG. 13C), including audience name, relative percentile, number of users, mean, median, range and total revenue predicted.

FIG. 13D illustrates predicted options associated with behavior and revenue, in accordance with an example implementation of the present application. With regard to behavioral predictions, FIG. 13D illustrates a likelihood to opt out of any messaging within 7 days, predicted number of pageviews a user will generate in the next 30 days, a predicted number of clicks a user will generate in the next 7 days, and a predicted total amount of messages a user will receive in the next day. With regard to predicted revenue, FIG. 13D illustrates a likelihood of a user to purchase within the next day, the next 7 days, the next 30 days, as well as predicted numbers of items in a cart, predicted item value, predicted transaction total of a purchase, a predicted total amount of revenue a user will generate over the next 30 days and the predicted total revenue a user will generate over the next 365 days.

FIG. 13E illustrates interactive functionality providing information in response to a selection of a portion segment within a predicted revenue graph. In the example shown in FIG. 13E, audience information corresponding to the segment is displayed, including percentile, number of users, and mean, median, range and total predicted revenue in the next 365 is shown.

FIGS. 13F and 13G illustrate options associated with defining a new segment (“audience”). In FIG. 13F, a windowed button “Add Audience,” when selected, causes one or more instructions to be executed by information processor 102 and/or user computing device 104 to launch an interactive data entry form (FIG. 13G), such as to name an audience and define starting and ending percentile values.

FIGS. 13H and 13I illustrate example interactive functionality associated with the audience table illustrated in the data entry display screen. As shown in FIG. 13H, a plurality of respective checkboxes are provided with each of the plurality of audiences, with each of the audiences selected, and the first audience is in the process of being deselected. In response and as shown in FIG. 13I, after the first audience is deselected, its corresponding range is eliminated from the graph. Thus, as illustrated in FIGS. 13H and 13I, selectable options are available for providing custom graphical views of segments of a user base are provided in an interactive graphical user interface.

Thus, as shown and described herein, the present application provides for various business applications, platform integration, interactive data visualizations and data management capabilities that employee or otherwise are based on predictions. Such predictions are dynamically provided as a function of various data modeling tools and algorithms, and dynamically increases accuracy of predictions as models adapt, substantially as shown and described herein. Such predictive measures effectively increase the likelihood of capturing user 306 interests, including based upon respective devices, time, geography, purchase history and future likelihood. Particular inventory, styles, sizes, colors brands can be recommended as a function of the likelihood of a user responding accordingly. Respective communication channels and data are unified and processed substantially in real-time to predict future behavior, provide recommendations that drive user actions, and optimize data flow. The present application hacks on the future rather than reacting to past behavior, and leverages hundreds of data points per user 306 rather than a handful (e.g., two or three). Moreover, the present application provides for extremely precise contemplations, such as by calibrating individuals versus the course segmentation over a larger population. Models are rebuilt periodically and regularly, such as every day, to reflect very recent trends, which further increases accuracy.

Although the present invention has been described in relation to particular embodiments thereof, many other variations and modifications and other uses will become apparent to those skilled in the art. It is preferred, therefore, that the present invention not be limited by the specific disclosure herein.

What is claimed:

1. A computer-implemented method for applying machine learning to define at least one respective segment of a user base and predicting behavior associated with the segment, the method comprising for a recommendation, the method comprising:
processing, using at least one processor, electronic usage information associated with recency, frequency and monetary spending from a plurality of computing devices associated with a user base representing a plurality of users;
associating, using the at least one processor, the electronic usage information with activity;
segmenting, using the at least one processor, a portion of the user base as a function of the associated electronic usage activity;
processing, using the at least one processor, the associated electronic usage information and the segmented portion of the user base to generate at least one predictive model of future behavior of the segmented portion;
determining, using the at least one processor, a respective recommendation of a good and/or service for each of the users in the segmented portion of the user base in accordance with the at least one generated predictive model; and
providing the respective recommendation to each computing device associated with the segmented portion.

2. The method of claim 1, further comprising providing, using the at least one processor, a user interface that includes an interactive graph that identifies the segmented portion of the users and the predictive model associated with the segmented portion, wherein the user interface is provided on each of a plurality of user computing devices.

3. The method of claim 1, further comprising determining predictive behavior, using at least one processor, at least one of:
a likelihood of a user to open an email message within a period of time;
a likelihood of a user to purchase an item within a period of time;
a total transaction amount made within a period of time;
a likelihood of a user to opt out of an email campaign; and
a total number of email messages a user will receive within a period of time.

4. The method of claim 3, wherein at least one of the segmenting and the generating the predictive model is based on or associated with the predictive behavior.

5. The method of claim 1, further comprising defining, using the at least one processor, at least one inflection point within the plurality of users; and
graphically representing the inflection point in an output display.

6. The method of claim 5, further comprising:
building, using at least one processor, a decision tree learning model;
training, using at least one processor, the decision tree learning model as a function of a k-Tile values associated with at least some of the user base; and
using the trained decision tree learning model to define the at least one inflection point.

7. The method of claim 6, further comprising:
adapting, using the at least one processor, the at least one predictive model by processing information associated with new user interactions,
wherein the adapting is made as a function of a degree of complexity of the decision tree learning model and the information associated with new user interactions.

8. The method of claim 5, further comprising:
determining, using at least one processor, an interpolation function of a second derivative as a function of a k-Tile values associated with at least some of the user base;
identifying at least one point in which the second derivative is equal to zero; and
using the at least one point as the at least one inflection point.

9. The method of claim 1, further comprising:
executing, using at least one processor, at least one module to enable a gradient boosting machine to predict user behavior.

10. The method of claim 9, wherein the module executes at least one historical experiment based on past data and validates the at least one historical experiment using observed user behavior during a predetermined time period.

11. A system comprising at least one processor configured to interact with a computer-readable medium in order to perform operations to apply machine learning to define at least one respective segment of a user base and predicting behavior associated with the segment, the method comprising for a recommendation, the system comprising:
processing, using at least one processor, electronic usage information associated with recency, frequency and monetary spending from a plurality of computing devices associated with a user base representing a plurality of users;
associating, using the at least one processor, the electronic usage information with activity;
segmenting, using the at least one processor, a portion of the user base as a function of the associated electronic usage activity;
processing, using the at least one processor, the associated electronic usage information and the segmented portion of the user base to generate at least one predictive model of future behavior of the segmented portion;
determining, using the at least one processor, a respective recommendation of a good and/or service for each of the users in the segmented portion of the user base in accordance with the at least one generated predictive model; and
providing the respective recommendation to each computing device associated with the segmented portion.

12. The system of claim 11, further configured to perform operations comprising:
providing, using the at least one processor, a user interface that includes an interactive graph that identifies the segmented portion of the users and the predictive model associated with the segmented portion, wherein the user interface is provided on each of a plurality of user computing devices.

13. The system of claim 11, further configured to perform operations comprising:
determining predictive behavior, using at least one processor, at least one of:
a likelihood of a user to open an email message within a period of time;
a likelihood of a user to purchase an item within a period of time;
a total transaction amount made within a period of time;
a likelihood of a user to opt out of an email campaign; and
a total number of email messages a user will receive within a period of time.

14. The system of claim 13, wherein at least one of the segmenting and the generating the predictive model is based on or associated with the predictive behavior.

15. The system of claim 11, further configured to perform operations comprising:
defining, using the at least one processor, at least one inflection point within the plurality of users; and
graphically representing the inflection point in an output display.

16. The system of claim 15, further configured to perform operations comprising:
building, using at least one processor, a decision tree learning model;
training, using at least one processor, the decision tree learning model as a function of a k-Tile values associated with at least some of the user base; and
using the trained decision tree learning model to define the at least one inflection point.

17. The system of claim 16, further configured to perform operations comprising:
adapting, using the at least one processor, the at least one predictive model by processing information associated with new user interactions,
wherein the adapting is made as a function of a degree of complexity of the decision tree learning model and the information associated with new user interactions.

18. The system of claim 15, further configured to perform operations comprising:
determining, using at least one processor, an interpolation function of a second derivative as a function of a k-Tile values associated with at least some of the user base;
identifying at least one point in which the second derivative is equal to zero; and
using the at least one point as the at least one inflection point.

19. The system of claim 11, further configured to perform operations comprising:
executing, using at least one processor, at least one module to enable a gradient boosting machine to predict user behavior.

20. The system of claim 19, wherein the module executes at least one historical experiment based on past data and validates the at least one historical experiment using observed user behavior during a predetermined time period.
